(19) United States
(12) Patent Application Publication
(10) Pub. No.: US 2023/0206249 A1
(43) Pub. Date: Jun. 29, 2023

(54) METHOD AND SYSTEM FOR PERFORMING INTERCEPTION AND AUDITING SERVICES IN COMPOSED INFORMATION HANDLING SYSTEMS

(71) Applicant: Dell Products L.P., Round Rock, TX (US)

(72) Inventors: Sumedh Wasudeo Sathaye, Austin, TX (US); Gaurav Chawla, Austin, TX (US)

(21) Appl. No.: 17/562,791

(22) Filed: Dec. 27, 2021

(51) Int. Cl. G06Q 30/00

(52) U.S. Cl. CPC G06Q 30/018

(57) ABSTRACT

Techniques described herein relate to a method for performing interception and auditing services for composed information handling systems. The method includes obtaining, by a system control processor manager, a request to perform interception and auditing from a user; and in response to obtaining the request: identifying an interception and auditing intent associated with the request; making a determination that the user is authorized to perform the interception and auditing intent; in response to the determination: identifying a composed system associated with the request; setting up interception and auditing services using an interception and auditing policy and function repository based on the intent; and initiating performance of the interception and auditing services using an at least one control resource set of the composed system.

### BACKGROUND

Computing devices may provide services. To provide the services, the computing devices may include hardware components and software components. The services provided by the computing devices may be limited by these components. The hardware components and software components may be allocated to provide the services. Users may use the computing devices for unintended purposes. It may be desirable to identify and track the use of the computing devices to ensure legal compliance.

### SUMMARY

In general, certain embodiments described herein relate to a method for performing interception and auditing services for composed information handling systems. The method may obtaining, by a system control processor manager, a request to perform interception and auditing from a user; and in response to obtaining the request: identifying an interception and auditing intent associated with the request; making a determination that the user is authorized to perform the interception and auditing intent; in response to the determination: identifying a composed system associated with the request; setting up interception and auditing services using an interception and auditing policy and function repository based on the intent; and initiating performance of the interception and auditing services using an at least one control resource set of the composed system.

In general, certain embodiments described herein relate to a system for performing interception and auditing services for composed information handling systems. The system includes a plurality of information handling systems, that include a plurality of system control processors; and a system control processor manager, which includes a processor and memory, programmed to: obtain a request to perform interception and auditing from a user; and in response to obtaining the request: identify an interception and auditing intent associated with the request; make a determination that the user is authorized to perform the interception and auditing intent; in response to the determination: identify a composed system associated with the request; set up interception and auditing services using an interception and auditing policy and function repository based on the intent; and initiate performance of the interception and auditing services using an at least one control resource set of the composed system.

In general, certain embodiments described herein relate to a non-transitory computer readable medium that includes computer readable program code, which when executed by a computer processor enables the computer processor to perform a method for performing interception and auditing services for composed information handling systems. The method may include obtaining, by a system control processor manager, a request to perform interception and auditing from a user; and in response to obtaining the request: identifying an interception and auditing intent associated with the request; making a determination that the user is authorized to perform the interception and auditing intent; in response to the determination: identifying a composed system associated with the request; setting up interception and auditing services using an interception and auditing policy and function repository based on the intent; and initiating performance of the interception and auditing services using an at least one control resource set of the composed system.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system in accordance with one or more embodiments of the invention.

FIG. 1.2 shows a diagram of an information handling system in accordance with one or more embodiments of the invention.

FIG. 2 shows a diagram of hardware resources in accordance with one or more embodiments of the invention.

FIG. 3 shows a diagram of a system control processor in accordance with one or more embodiments of the invention.

FIG. 4 shows a diagram of a system control processor manager in accordance with one or more embodiments of the invention.

FIG. 5.1 shows a flowchart of a method for instantiating a composed information handling system in accordance with one or more embodiments of the invention.

FIG. 5.2 shows a flowchart of a method for managing interception and auditing services in accordance with one or more embodiments of the invention.

FIG. 5.3 shows a flowchart of a method for performing interception and auditing services in accordance with one or more embodiments of the invention.

FIG. 6 shows a diagram of the operation of an example system over time in accordance with one or more embodiments of the invention.

FIG. 7 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general embodiments of the invention relate to methods, systems, and non-transitory computer readable mediums for performing interception and auditing services for composed information handling systems.

In one or more embodiments of the invention, composed information handling system are composed to perform computer implemented services. A composed information handling system may be a device (the components of which may be distributed across one or more information handling systems) that has exclusive use over a quantity of computing resources. Computing resources from multiple information handling systems may be allocated to a composed information handling system thereby enabling a composed information handling system to utilize computing resources from any number of information handling system for performance of corresponding computer implemented services.

To allocate computing resources, the system may include a system control processor manager. The system control processor manager may obtain composition requests. The composition requests may indicate a desired outcome such as, for example, execution of one or more applications, providing of one or more services, etc. The system control processor manager may translate the composition requests into corresponding quantities of computing resources necessary to be allocated to satisfy the intent of the composition requests.

The users of composed information handling systems may use the composed information handling systems to perform nefarious or otherwise undesirable activities. The nefarious activities may include any undesired activity without departing from the invention. The nefarious activities may include, for example, illegal bitcoin mining, insider trading, and/or other undesirable activities. Other users (e.g., system administrators of information handling systems, law enforcement officials, etc.) may desire to monitor the composed information handling systems to identify and/or track such nefarious activities without the knowledge of the users of the composed information handling system. If the users of the composed information handling systems become aware of attempts to identify or track nefarious activities on their corresponding composed information handling systems, then the users may tamper with or evade (e.g., delete data relevant to an investigation or an audit) the aforementioned attempts to identify or track nefarious activities.

To address, at least in part, the aforementioned issues, embodiments of the invention relate to providing interception and auditing services for composed information handling systems. Specifically, embodiments of the invention may: (i) enable users to submit interception and auditing requests associated with a particular interception and auditing intent, (ii) provide a system control processor manager that may verify the authorization of user to request the interception and auditing intents, (iii) setup interception and auditing services to satisfy the interception and auditing intent, and (iv) to perform the interception and auditing services without the involvement or knowledge of target users (i.e., users of composed information handling systems for which interception and auditing services are to be performed) of the composed information handling systems. Consequently, even though the resulting composed information handling systems may be used by target users, interception and auditing services may be performed to identify and track nefarious activities of the target users without the knowledge or tampering of the interception and auditing services by the target users.

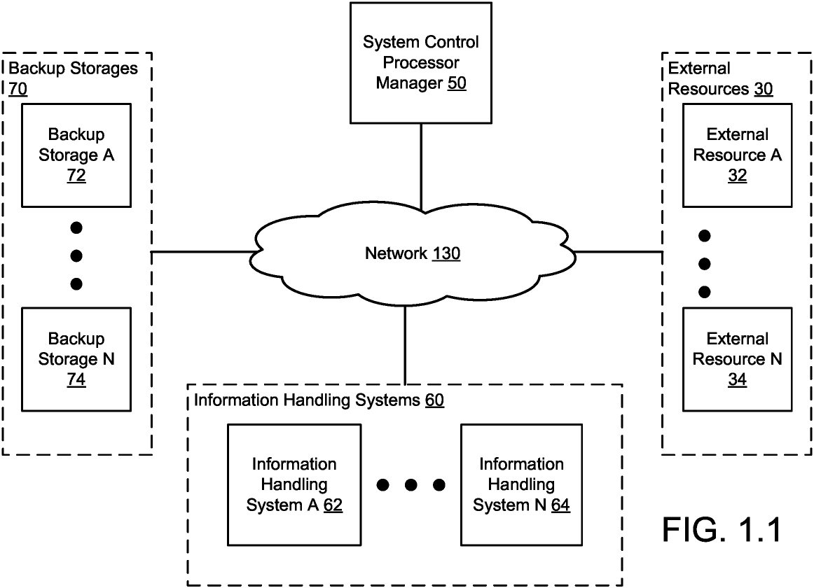

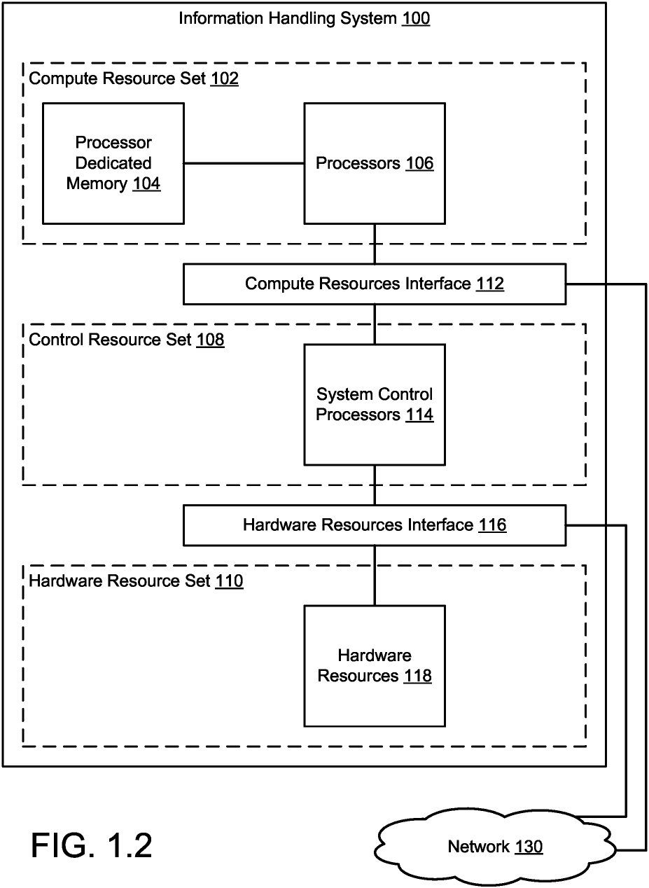

FIG. 1.1 shows a system in accordance with one or more embodiments of the invention. The system may include any number of information handling systems (60). The information handling systems (60) may provide computer implemented services. The computer implemented services may include, for example, database services, data storage services, electronic communications services, data protection services, and/or other types of services that may be implemented using information handling systems.

The information handling system of the system of FIG. 1.1 may operate independently and/or cooperatively to provide the computer implemented services. For example, a single information handling system (e.g., 60) may provide a computer implemented service on its own (i.e., independently) while multiple other information handling systems (e.g., 62, 64) may provide a second computer implemented service cooperatively (e.g., each of the multiple other information handling systems may provide similar and or different services that form the cooperatively provided service).

To provide computer implemented services, the information handling systems (60) may utilize computing resources provided by hardware devices. The computing resources may include, for example, processing resources, storage resources, memory resources, graphics processing resources, communications resources, and/or other types of resources provided by the hardware devices. Various hardware devices may provide these computing resources.

As discussed above, embodiments of the invention relate to system, methods, and devices for managing the hardware resources of the information handling systems (60) and/or other resources (e.g., external resources (30)) to perform interception and auditing services for composed information handling systems and the information handling systems (60). The hardware resources of the information handling systems (60) may be managed by instantiating one or more composed information handling systems using the hardware resources of the information handling systems (60), external resources (30), and/or other types of hardware devices operatively connected to the information handling systems (60). During the instantiation of the composed information handling systems, one or more devices, including a system control processor, may be automatically setup to perform interception and auditing services for the composed information handling system, including: (i) obtaining requests to perform interception and auditing services from the system control processor manager (50), (ii) instantiating, performing, and/or managing interception and auditing services, (iii) generating, maintaining, and/or obtaining interception and auditing information, and (iv) providing interception and auditing information to users and/or the system control processor manager (50). Consequently, interception and auditing services may result in the generation of interception and auditing information. The interception and auditing information may be used to identify and/or track nefarious activities and/or ensure legal compliance of targeted users of composed information handling systems.

In one or more embodiments of the invention, the system includes a system control processor manager (50). The system control processor manager (50) may provide composed information handling system composition services. Composed information handling system composition services may include (i) obtaining composition requests for composed information handling systems and (ii) aggregating computing resources from the information handling systems (60) and/or external resources (30) using system control processors to service the composition requests by instantiating composed information handling systems in accordance with the requests. By doing so, instantiated composed information handling systems may provide computer implemented services in accordance with the composition requests.

In one or more embodiments of the invention, the system control processor manager (50) instantiates composed information handling systems in accordance with a three resource set model. As will be discussed in greater detail below, the computing resources of an information handling system may be divided into three logical resource sets: a compute resource set, a control resource set, and a hardware resource set. Different resource sets, or portions thereof, from the same or different information handling systems may be aggregated (e.g., caused to operate as a computing device) to instantiate a composed information handling system having at least one resource set from each set of the three resource set model.

By logically dividing the computing resources of an information handling system into these resource sets, different quantities an types of computing resources may be allocated to each composed information handling system thereby enabling the resources allocated to the respective information handling system to match performed workloads. Further, dividing the computing resources in accordance with the three set model may enable different resource sets to be differentiated (e.g., given different personalities) to provide different functionalities. Consequently, composed information handling systems may be composed on the basis of desired functionalities rather than just on the basis of aggregate resources to be included in the composed information handling system.

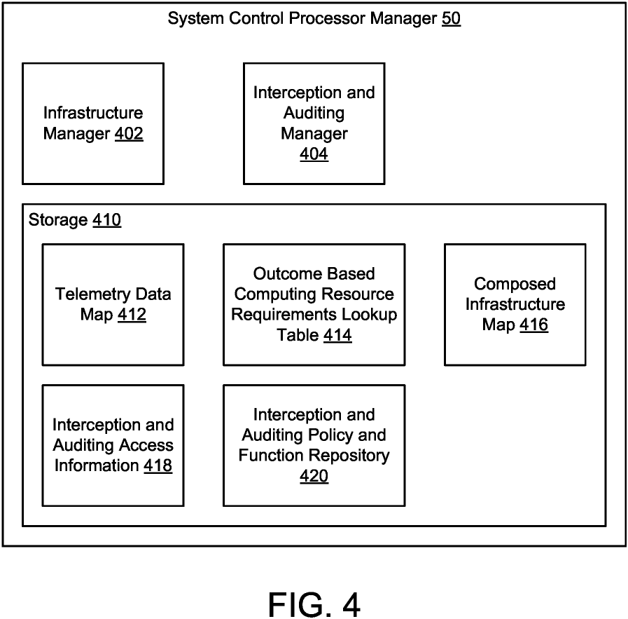

Additionally, by composing composed information handling systems in this manner, the control resource set of each composed information handling system may be used to consistently deploy management services across any number of composed information handling systems. Consequently, embodiments of the invention may provide a framework for unified security, manageability, resource management/composability, workload management, and distributed system management by use of this three resource set model. For additional details regarding the system control processor manager (50), refer to FIG. 4.

In one or more embodiments of the invention, a composed information handling system (also referred to herein as a composed system) is a device that is formed using all, or a portion, of the computing resources of the information handling systems (60), the external resources (30), and/or other types of hardware devices operatively connected to the information handling systems (60). The composed information handling system may utilize the computing resources allocated to it to provide computer implemented services. For example, the composed information handling system may host one or more applications that utilize the computing resources assigned to the composed information handling system. The applications may provide the computer implemented services.

To instantiate composed information handling systems, the information handling systems (60) may include at least three resource sets including a control resource set. The control resource set may include a system control processor. The system control processor of each information handling system may coordinate with the system control processor manager (50) to enable composed information handling systems to be instantiated. For example, the system control processor of an information handling system may provide telemetry data regarding the computing resources of an information handling system, may perform actions on behalf of the system control processor manager (50) to aggregate computing resources together, may organize the performance of duplicative workloads to improve the likelihood that workloads are completed, and/or may provide services that unify the operation of composed information handling systems.

In one or more embodiments of the invention, compute resource sets of composed information handling systems are presented with bare metal resources by control resource sets even when the presented resources are actually being managed using one or more layers of abstraction, emulation, virtualization, security model, etc. For example, the system control processors of the control resource sets may provide the abstraction, emulation, virtualization, data protection, and/or other services while presenting the resources as bare metal resources. Consequently, these services may be transparent to applications hosted by the compute resource sets of composed information handling systems thereby enabling uniform deployment of such services without requiring implementation of control plane entities hosted by the compute resource sets of the composed information handling systems. For additional details regarding the information handling systems (60), refer to FIG. 1.2.

The external resources (30) may be provide computing resources that may be allocated for use by composed information handling systems. For example, the external resources (30) may include hardware devices that provide any number and type of computing resources. The composed information handling system may use these resource to provide their functionalities. Different external resources (e.g., 32, 34) may provide similar or different computing resources.

In one or more embodiments of the invention, the system of FIG. 1.1 includes backup storages (70) that provide data storage services to the composed information handling systems. The backup storages (70) may include any number of backup storages, for example, the backup storages (70) may include backup storage A (72) and backup storage N (74). The data storage services may include storing of data provided by the composed information handling systems and providing previously stored data to the composed information handling systems. The data stored in backup storages (70) may be used for restoration purposes. The data stored in the backup storages (70) may be used for other purposes without departing from the invention. The data stored in backup storages (70) may include backups generated during the performance of data protection services of the composed information handling systems. The backups may be any type of backup (e.g., snapshot, incremental backup, full backup, etc.) without departing from the invention. The data stored in backup storages (70) may include other and/or additional types of data obtained from other and/or additional components without departing from the invention.

The system of FIG. 1.1 may include any number of information handling systems (e.g., 62, 64), any number of external resources (e.g., 32, 34), any number of backup storages (e.g., 72, 74), and any number of system control processor managers (e.g., 50). Any of the components of FIG. 1.1 may be operatively connected to any other component and/or other components not illustrated in FIG. 1.1 via one or more networks (e.g., 130). The networks may be implemented using any combination of wired and/or wireless network topologies.

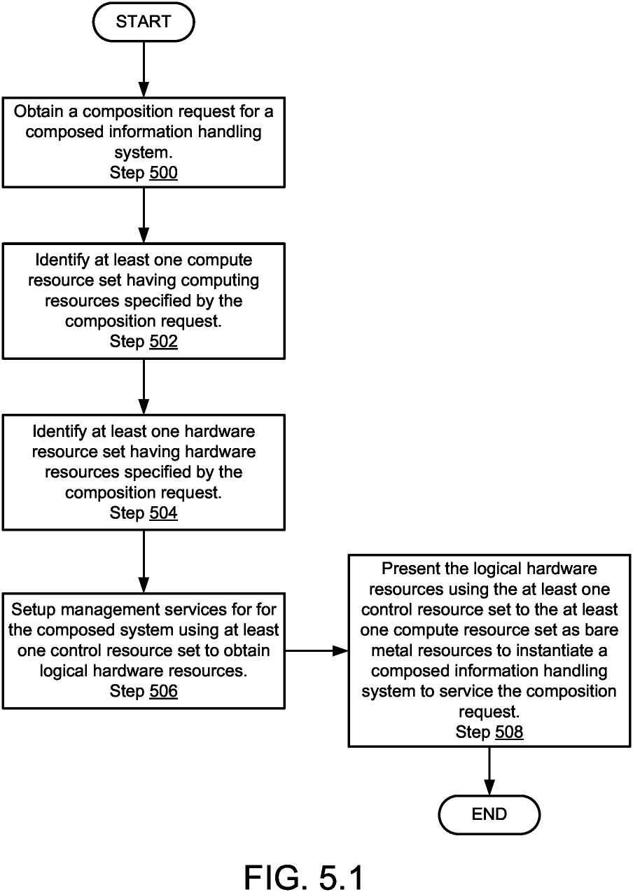

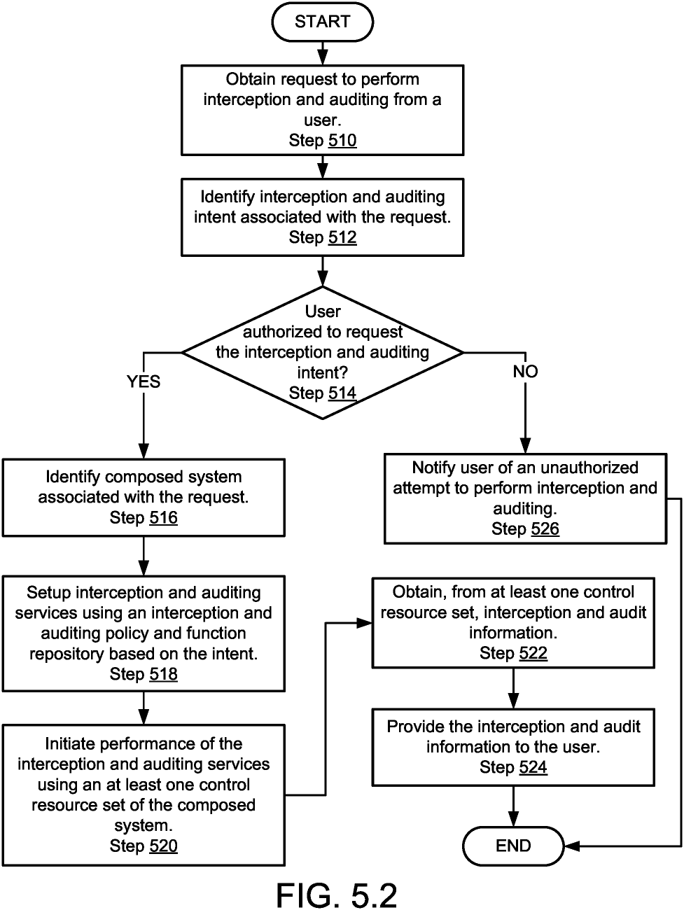

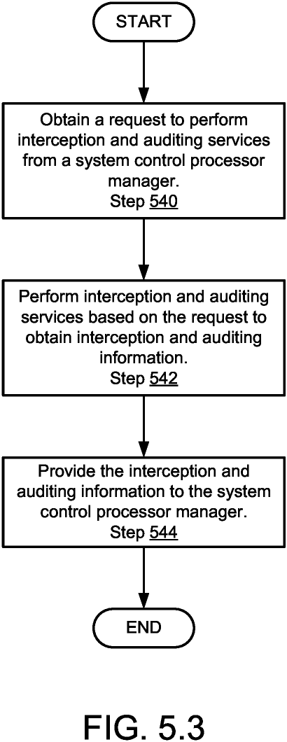

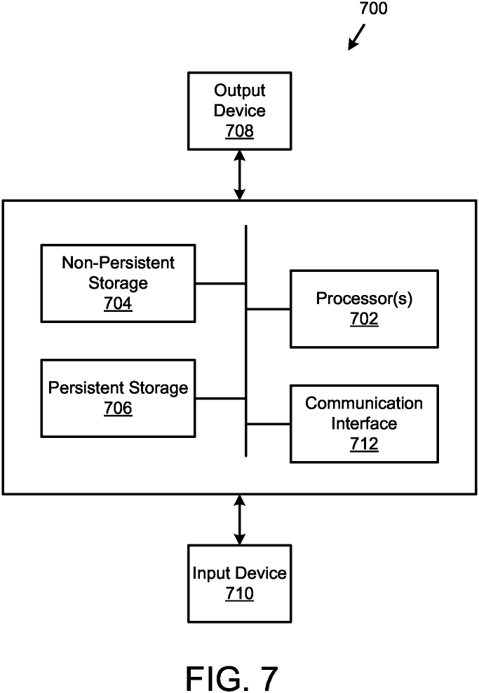

The system control processor manager (50), information handling systems (60), backup storages (70), and/or external resources (30) may be implemented using computing devices. The computing devices may include, for example, a server, laptop computer, a desktop computer, a node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor manager (50), information handling systems (60), backup storages (70), and/or external resources (30) described in this application and/or all, or a portion, of the methods illustrated in FIGS. 5.1 - 5.3. The system control processor manager (50), information handling systems (60), backup storages (70), and/or external resources (30) may be implemented using other types of computing devices without departing from the invention. For additional details regarding computing devices, refer to FIG. 7.

While the system has been illustrated and described as including a limited number of specific components, a system in accordance with embodiments of the invention may include additional, fewer, and/or different components without departing from the invention.

Turning to FIG. 1.2, FIG. 1.2 shows a diagram of an information handling system (100) in accordance with one or more embodiments of the invention. Any of the information handling systems (e.g., 60) of FIG. 1.1 may be similar to the information handling system (100) illustrated in FIG. 1.2.

As discussed above, the information handling system (100) may provide any quantity and type of computer implemented services. To provide the computer implemented services, resources of the information handling system may be used to instantiate one or more composed information handling systems. The composed information handling systems may provide the computer implemented services.

To provide computer implemented services, the information handling system (100) may include any number and type of hardware devices including, for example, one or more processors (106), any quantity and type of processor dedicated memory (104), one or more system control processors (114), and any number of hardware resources (118). These hardware devices may be logically divided into three resource sets including a compute resource set (102), a control resource set (108), and a hardware resource set (110).

The control resource set (108) of the information handling system (100) may facilitate formation of composed information handling systems and perform interception and auditing services. To do so, the control resource set (108) may prepare any quantity of resources from any number of hardware resource sets (e.g., 110) (e.g., of the information handling system (100) and/or other information handling systems) for presentation to processing resources of any number of computing resource sets (e.g., 102) (e.g., of the information handling system (100) and/or other information handling systems). Once prepared, the control resource set (108) may present the prepared resources as bare metal resources to the processors (e.g., 106) of the allocated computing resources. By doing so, a composed information handling system may be instantiated. Additionally, the control resource set (108) may prepare hardware resource sets (e.g., 110) or other computer resources (e.g., system control processors (114)) to perform interception and auditing services.

To prepare the resources of the hardware resource sets for presentation, the control resource set (108) may employ, for example, virtualization, indirection, abstraction, and/or emulation. These management functionalities may be transparent to applications hosted by the resulting instantiated composed information handling systems. Consequently, while unknown to the control plane entities of the composed information handling system, the composed information handling system may operate in accordance with any number of management models thereby providing for unified control and management of composed information handling systems. These functionalities may be transparent to applications hosted by composed information handling systems thereby relieving them from overhead associated with these functionalities.

For example, consider a scenario where a compute resource set is instructed to instantiate a composed information handling system including a compute resource set and a hardware resource set that will contribute storage resources to the compute resource set. The compute resource set may virtualize the storage resources of the hardware resource set to enable a select quantity of the storage resources to be allocated to the composed information handling system while reserving some of the storage resources for allocation to other composed information handling systems. However, the prepared storage resources may be presented to the compute resource set as bare metal resources. Consequently, the compute resource set may not need to host any control plane entities or otherwise incur overhead for utilizing the virtualized storage resources.

The compute resource set (102) may include one or more processors (106) operatively connected to the processor dedicated memory (104). Consequently, the compute resource set (102) may host any number of executing processes thereby enabling any number and type of workloads to be performed. When performing the workloads, the compute resource set (102) may utilize computing resources provided by the hardware resource set (110) of the information handling system (100), hardware resource sets of other information handling systems, and/or external resources.

The processors (106) of the compute resource set (102) may be operatively connected to one or more system control processors (114) of the control resource set (108). For example, the processors (106) may be connected to a compute resource interface (112), which is also connected to the system control processors (114).

The system control processors (114) of the control resource set (108) may present computing resources to the processors (106) as bare metal resources. In other words, from the point of view of the processors (106), any number of bare metal resources may be operatively connected to it via the compute resources interface (112) when, in reality, the system control processors (114) are operatively connected to the processors (106) via the compute resources interface (112). In other words, the system control processors (114) may manage presentation of other types of resources to the compute resource set (102).

By presenting the computing resources to the processors as bare metal resources, control plane entities (e.g., applications) such as hypervisors, emulators, and/or other types of management entities may not need to be hosted (e.g., executed) by the processors (106) for the processors (106) and entities hosted by them to utilize the computing resources allocated to a composed information handling system. Accordingly, all of the processing resources provided by the compute resource set (102) may be dedicated to providing the computer implemented services.

For example, the processors (106) may utilize mapped memory addresses to communicate with the bare metal resources presented by the system control processors (114) to the processors (106). The system control processors (114) may obtain these communications and appropriately remap (e.g., repackage, redirect, encapsulate, etc.) the communications to the actual hardware devices providing the computing resources, which the processors (106) are interacting with via the compute resources interface (112) and/or hardware resources interface (116), discussed below. Consequently, indirection, remapping, and/or other functions required for resource virtualization, emulation, abstraction, or other methods of resource allocation (other than bare metal) and manage may not need to be implemented via the processors (106).

By doing so, any number of functions for a composed information handling system may be automatically performed in a manner that is transparent to the control plane. Accordingly, a composed information handling system may operate in a manner consistent with a unified, consistent architecture or model (e.g., communications model, data storage model, etc.) by configuring the operation of one or more system control processors in a manner consistent with the architecture or model.

In one or more embodiments of the invention, control plane entities utilize computing resources presented through one or more layers of indirection, abstraction, virtualization, etc. In other words, an indirect user of hardware devices and computing resources provided thereby.

In one or more embodiments of the invention, data plane entities directly utilize computing resources. For example, data plane entities may instruct hardware devices on their operation thereby directly utilizing computing resources provided thereby. Data plane entities may present the computing resources to control plane entities using one or more layers of indirection, abstraction, virtualization, etc.

The system control processors (114) may present any number of resources operatively connected to it (e.g., the hardware resource set (110), other resources operatively connected to it via an interface (e.g., hardware resources interface (116), etc.) as bare metal resources to the processors (106) of the compute resource set (102). Consequently, the system control processors (114) may implement device discovery processes compatible with the processors (106) to enable the processors (106) to utilize the presented computing resources.

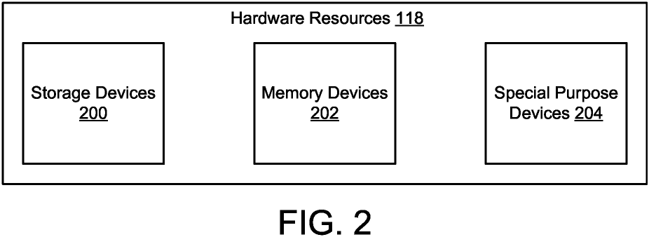

For example, the hardware resource set (110) may include hardware resources (118) operatively connected to the system control processors (114) via a hardware resources interface (116). The hardware resources (118) may include any number and type of hardware devices that provide computing resources. For additional details regarding the hardware resources (118), refer to FIG. 2.

In another example, the system control processors (114) may be operatively connected to other hardware resource sets of other information handling systems via hardware resources interface (116), network (130), and/or other system control processors of the other information handling systems. The system control processors (114) may cooperatively enable hardware resource sets of other information handling systems to be prepared and presented as bare metal resources to the compute resource set (102).

In an additional example, the system control processors (114) may be operatively connected to external resources via hardware resources interface (116) and network (130). The system control processors (114) may prepare and present the external resources as bare metal resources to the compute resource set (102).

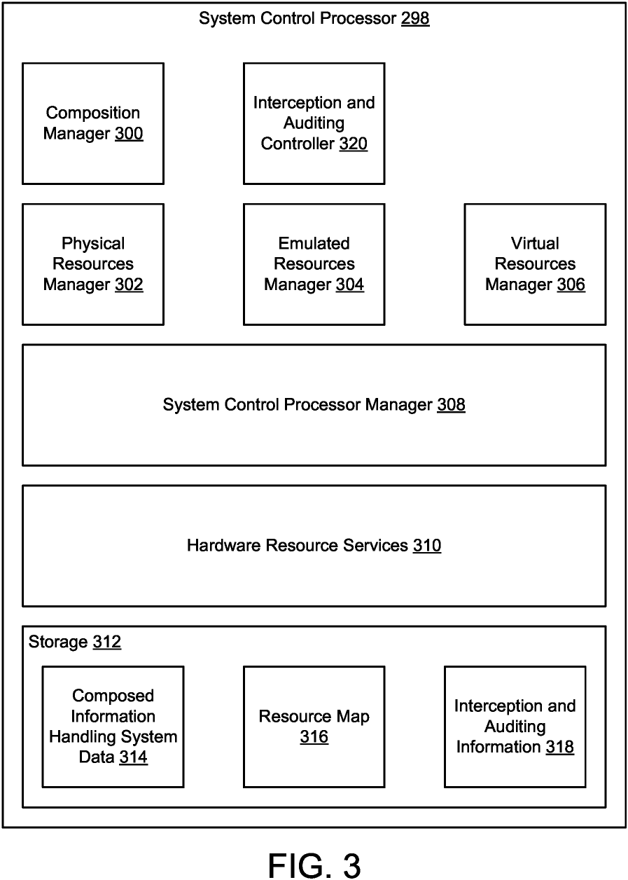

For additional details regarding the operation and functions of the system control processors (114), refer to FIG. 3.

The compute resources interface (112) may be implemented using any suitable interconnection technology including, for example, system buses such as compute express links or other interconnection protocols. The compute resources interface (112) may support any input/output (IO) protocol, any memory protocol, any coherence interface, etc. The compute resources interface (112) may support processor to device connections, processor to memory connections, and/or other types of connections. The compute resources interface (112) may be implemented using one or more hardware devices including circuitry adapted to provide the functionality of the compute resources interface (112).

The hardware resources interface (116) may be implemented using any suitable interconnection technology including, for example, system buses such as compute express links or other interconnection protocols. The hardware resources interface (116) may support any input/output (IO) protocol, any memory protocol, any coherence interface, etc. The hardware resources interface (116) may support processor to device connections, processor to memory connections, and/or other types of connections. The hardware resources interface (116) may be implemented using one or more hardware devices including circuitry adapted to provide the functionality of the hardware resources interface (116).

In some embodiments of the invention, the compute resource set (102), control resource set (108), and/or hardware resource set (110) may be implemented as separate physical devices. In such a scenario, the compute resources interface (112) and hardware resources interface (116) may include one or more networks enabling these resource sets to communicate with one another. Consequently, any of these resource sets (e.g., 102, 108, 110) may include network interface cards or other devices to enable the hardware devices of the respective resource sets to communicate with each other.

In one or more embodiments of the invention, the system control processors (114) support multiple, independent connections. For example, the system control processors (114) may support a first network communications connection (e.g., an in-band connection) that may be allocated for use by applications hosted by the processors (106). The system control processors (114) may also support a second network communications connection (e.g., an out-of-band connection) that may be allocated for use by applications hosted by the system control processors (114). The out-of-ban connection may be utilized for management and control purposes while the in-band connection may be utilized to provide computer implemented services. These connections may be associated with different network endpoints thereby enabling communications to be selectively directed toward applications hosted by the processors (106) and/or system control processors (114). As will be discussed in greater detail with respect to FIG. 3, the system control processors (114) may utilize the out-of-band connections to communicate with other devices to manage (e.g., instantiate, monitor, modify, etc.) composed information handling systems.

The network (130) may correspond to any type of network and may be operatively connected to the Internet or other networks thereby enabling the information handling system (100) to communicate with any number and type of other devices.

The information handling system (100) may be implemented using computing devices. The computing devices may be, for example, a server, laptop computer, desktop computer, node of a distributed system, etc. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the information handling system (100) described in this application and/or all, or a portion, of the methods illustrated in FIGS. 5.1 - 5.3. The information handling system (100) may be implemented using other types of computing devices without departing from the invention. For additional details regarding computing devices, refer to FIG. 7.

While the information handling system (100) has been illustrated and described as including a limited number of specific components, an information handling system in accordance with embodiments of the invention may include additional, fewer, and/or different components without departing from the invention.

Turning to FIG. 2, FIG. 2 shows a diagram of the hardware resources (118) in accordance with one or more embodiments of the invention. As noted above, system control processors of information handling system may present resources including, for example, any portion of the hardware resources (118) to form a composed information handling system.

The hardware resources (118) may include any number and types of hardware devices that may provide any quantity and type of computing resources. For example, the hardware resources (118) may include storage devices (200), memory devices (202), and special purpose devices (204).

The storage devices (200) may provide storage resources (e.g., persistent storage) in which applications hosted by a composed information handling system may store data including any type and quantity of information. The system control processors or other entities may write data chunks to the storage devices (200). The storage devices (200) may include any type and quantity of devices for storing data. The devices may include, for example, hard disk drives, solid state drives, tape drives, etc. The storage devices (200) may include other types of devices for providing storages resources without departing from the invention. For example, the storage devices (200) may include controllers (e.g., redundant array of disk controllers), load balancers, and/or other types of devices.

The memory devices (202) may provide memory resources (e.g., transitory and/or persistent storage) in which a composed information handling system may store data including any type and quantity of information. The memory devices (202) may include any type and quantity of devices for storing data. The devices may include, for example, transitory memory such as random access memory, persistent memory such as enterprise class memory, etc. The memory devices (202) may include other types of devices for providing memory resources without departing from the invention. For example, the storage devices (200) may include controllers (e.g., replication managers), load balancers, and/or other types of devices.

The special purpose devices (204) may provide other types of computing resources (e.g., graphics processing resources, computation acceleration resources, etc.) to composed information handling systems. The special purpose devices (204) may include any type and quantity of devices for providing other types of computing resources. The special purpose devices (204) may include, for example, graphics processing units for providing graphics processing resources, compute accelerators for accelerating corresponding workloads performed by composed information handling systems, application specific integrated circuits (ASICs) for performing other functionalities, digital signal processors for facilitating high speed communications, etc. The special purpose devices (204) may include other types of devices for providing other types of computing resources without departing from the invention.

The system control processors of the information handling systems may mediate presentation of the computing resources provided by the hardware resources (118) to computing resource sets (e.g., as bare metal resources to processors). When doing so, the system control processors may provide a layer of abstraction that enables the hardware resources (118) to be, for example, virtualized, emulated as being compatible with other systems, and/or directly connected to the compute resource sets (e.g., pass through). Consequently, the computing resources of the hardware resources (118) may be finely, or at a macro level, allocated to different composed information handling systems.

Additionally, the system control processors may manage operation of these hardware devices in accordance with one or more models, including interception and auditing models. The models may include other models such as, for example, security models, workload performance availability models, reporting models, etc. The interception and auditing models may include performing interception and auditing services for composed information handling systems. For additional information regarding the performance of interception and auditing services, refer to FIGS. 5.2 - 5.3.

The manner of operation of these devices (i.e., the performance of the aforementioned interception and auditing services) may be transparent to the computing resource sets and users utilizing the hardware devices for providing computer implemented services. Consequently, even though the resulting composed information handling system control plane and users may be unaware of the implementation of these models, the composed information handling systems may still operate in accordance with these models thereby providing a reliable and secure method of performing the interception and auditing services for composed information handling systems.

While the hardware resources (118) have been illustrated and described as including a limited number of specific components, hardware resources (118) in accordance with embodiments of the invention may include additional, fewer, and/or different components without departing from the invention.

As discussed above, information handling systems may include system control processors that may be used to instantiate composed information handling systems. FIG. 3 shows a diagram of a system control processor (298) in accordance with one or more embodiments of the invention. Any of the system control processors included in control resources sets of FIG. 1.2 may be similar to the system control processor (298) illustrated in FIG. 3.

The system control processor (298) may facilitate instantiation and operation of composed information handling systems. By doing so, a system that includes information handling systems may dynamically instantiate composed information handling systems to provide computer implemented services and to provide local interception and auditing services for the composed information handling system.

To instantiate and operate composed information handling systems, the system control processor (298) may include a composition manager (300), a physical resources manager (302), an emulated resources manager (304), a virtual resources manager (306), an interception and auditing controller (320), an system control processor manager (308), hardware resource services (310), and storage (312). Each of these components of the system control processor is discussed below.

The composition manager (300) may manage the process of instantiating and operating composed information handling systems. To provide these management services, the composition manager (300) may include functionality to (i) obtain information regarding the hardware components of the information handling system (e.g., obtain telemetry data regarding the information handling system), (ii) provide the obtained information to other entities (e.g., management entities such as system control processor manager (50, FIG. 1.1)), (iii) obtain composition requests for composed information handling systems, (iv) based on the composition requests, prepare and present resources as bare metal resources to compute resource sets, (v) instantiate applications in composed information handling systems to cause the composed information handling systems to provide computer implemented services, conform their operation to security models, etc., (vi) add/remove/modify resources presented to the compute resource sets of composed information handling systems dynamically in accordance with workloads being performed by the composed information handling systems, and/or (vii) coordinate with other system control processors to provide distributed system functionalities. By providing the above functionalities, a system control processor in accordance with one or more embodiments of the invention may enable distributed resources from any number of information handling systems to be aggregated into a composed information handling system to provide computer implemented services.

To obtain information regarding the hardware components of the information handling system, the composition manager (300) may inventory the components of the information handling system hosting the system control processor. The inventory may include, for example, the type and model of each hardware component, versions of firmware or other code executing on the hardware components, and/or other information regarding hardware components of the information handling system that may be allocated to form composed information handling systems.

The composition manager (300) may obtain composition requests from other entities (e.g., management entities tasked with instantiating composed information handling systems) as pre-loaded instructions present in storage of the system control processor, and/or via other methods. The composition requests may specify, for example, the types and quantities of computing resources to be allocated to a composed information handling system.

In one or more embodiments of the invention, the composition requests specify the computing resource allocations using an intent based model. For example, rather than specifying specific hardware devices (or portions thereof) to be allocated to a particular compute resource set to obtain a composed information handling system, the resource requests may only specify that a composed information handling system is to be instantiated having predetermined characteristics, that a composed information handling system will perform certain workloads or execute certain applications, and/or that the composed information handling system be able to perform one or more predetermined functionalities. In such a scenario, the composition manager may decide how to instantiate the composed information handling system (e.g., which resources to allocate, how to allocate the resources (e.g., virtualization, emulation, redundant workload performance, data integrity models to employ, etc.), to which compute resource set(s) to present corresponding computing resources, etc.).

In one or more embodiments of the invention, the composition requests specify the computing resource allocations using an explicit model. For example, the composition requests may specify (i) the resources to be allocated, (ii) the manner of presentation of those resources (e.g., emulating a particular type of device using a virtualized resource vs. path through directly to a hardware component), and (iii) the compute resource set(s) to which each of the allocated resources are to be presented.

In addition to specifying resource allocations, the composition requests may also specify, for example, applications to be hosted by the composed information handling systems, security models to be employed by the composed information handling systems, communication models to be employed by the composed information handling systems, data protection services to be provided to the composed information handling systems, user/entity access credentials for use of the composed information handling systems, and/or other information usable to place the composed information handling systems into states in which the composed information handling systems provide desired computer implemented services.

To prepare and present resources to compute resource sets based on the composition requests, the system control processors may implement, for example, abstraction, indirection, virtualization, mapping, emulation, and/or other types of services that may be used to present any type of resources as a resource that is capable of bare metal utilization by compute resource sets. To provide these services, the composition manager (300) may invoke the functionality of the physical resources manager (302), the emulated resources manager (304), and/or the virtual resources manager (306).

Additionally, the system control processors may take into account an importance of completion of workloads when preparing and presenting resources. For example, some workloads that may be performed by various hardware devices may be critical (e.g., high availability workloads) to the computer implemented services to be provided by a composed information handling system. In such a scenario, the system control processor may over allocate resources (e.g., beyond that requested by a compute resource set) for performance of the workloads so that at least two instances of the workloads can be performed using duplicative resources. By doing so, it may be more likely that at least one of the workloads will be completed successfully. Consequently, the system control processor may provide the output of one of the workloads to compute resource sets of a composed information handling system.

When presenting the resources to the compute resource sets, the system control processor (298) may present the resources using an emulated data plane. For example, the system control processors (298) may receive bare metal communications (e.g., IO from the processors) and respond in a manner consistent with responses of corresponding bare metal devices (e.g., memory). When doing so, the system control processor (298) may translate the communications into actions. The actions may be provided to the hardware devices used by the system control processor (298) to present the bare metal resources to the compute resource set(s). In turn, the hardware devices may perform the actions which results in a composed information handling system providing desired computer implemented services.

In some scenarios, multiple system control processors may cooperate to present bare metal resources to a compute resource set. For example, a single information handling system may not include sufficient hardware devices to present a quantity and/or type of resources to a compute resource set as specified by a composition requests (e.g., present two storage devices to a compute resource set when a single information handling system only includes a single storage device). In this scenario, a second system control processor of a second information handling system operatively connected to the system control processor tasked with presenting the resources to a compute resource set may prepare one of its storage devices for presentation. Once prepared, the second system control processor may communicate with the system control processor to enable the system control processor to present the prepared storage device (i.e., the storage device in the information handling system) to the compute resource set. By doing so, resources from multiple information handling system may be aggregated to present a desired quantity of resources to compute resource set(s) to form a composed information handling system.

By forming composed information handling systems as discussed above, embodiments of the invention may provide a system that is able to effectively utilize distributed resources across a range of devices to provide computer implemented services.

The physical resources manager (302) may manage presentation of resources to compute resource sets. For example, the physical resources manager (302) may generate, for example, translation tables that specify actions to be performed in response to bare metal communications obtained from compute resource sets. The translation tables may be used to take action in response to communications from compute resource sets.

The physical resources manager (302) may generate the translation tables based on the components of the compute resource sets, allocations or other types of commands/communications obtained from the compute resource sets, and the resources of the information handling system allocated to service the compute resource set. For example, when a compute resource set is presented with a bare metal resource, it may go through a discovery process to prepare the bare metal resource for use. As the discovery process proceeds, the compute resource set may send commands/communications to the bare metal resource to, for example, discover its address range. The physical resources manager (302) may monitor this process, respond appropriately, and generate the translation table based on these command and the resources available to service these bare metal commands/communications.

For example, consider a scenario where a virtualized disk is allocated to service bare metal storage commands from a compute resource set. In such a scenario, the physical resources manager (302) may generate a translation table that translates physical write from the compute resource set to virtualized writes corresponding to the virtualized disk. Consequently, the virtualized disk may be used by the system control processor (298) to present bare metal resources to the compute resource set.

The emulated resources manager (304) may generate emulation tables that enable resources that would otherwise be incompatible with a compute resource set to be compatible with the compute resource set. Different types of hardware devices of a compute resource set may be compatible with different types of hardware devices. Consequently, resources allocated to provide bare metal resources may not necessarily be compatible with the hardware devices of a compute resource set. The emulated resources manager (304) may generate emulation tables that map bare metal communications obtained from a compute resource set to actions that are compatible with resources allocated to provide bare metal resources to the compute resource sets.

The virtual resources manager (306) may manage virtualized resources that may be allocated to provide bare metal resources to compute resource sets. For example, the virtual resources manager (306) may include hypervisor functionality to virtualized hardware resources and allocate portions of the virtualized resources for use in providing bare metal resources.

While the physical resources manager (302), emulated resources manager (304), and virtual resources manager (306) have been described as generating tables, these components of the system control processor may generate other types of data structures or utilize different management models to provide their respective functionalities without departing from the invention.

To provide the aforementioned local interception and auditing services, the system control processor (298) may include the interception and auditing controller (320). The interception and auditing controller (320) may include the functionality to perform all, or a portion, of the local interception and auditing services. The local interception and auditing services may include (i) obtaining requests to perform interception and auditing services from a system control processor manager, (ii) instantiating, managing, and/or performing interception and auditing services based on interception and auditing functions and/or commands for one or more components of composed information handling systems specified by the interception and auditing zones included in the interception and auditing requests, (iii) generating and/or maintaining interception and auditing information (e.g., 318) for composed information handling systems operatively connected to the system control processor (298), and (iv) providing interception and auditing information to the system control processor manager (50). The local interception and auditing services may include other and/or additional services without departing from the invention. For additional information regarding the interception and auditing services, refer to FIG. 5.3. Other components of the system control processor (298) (e.g., composition manager (300)) may perform all, or a portion, of the local interception and auditing services without departing from the invention.

The functionalities of the physical resources manager (302), emulated resources manager (304), virtual resources manager (306), and the interception and auditing controller (320) may be utilized in isolation and/or combination to provide bare metal resources to compute resource sets and to provide management services to the composed information handling system. By doing so, the system control processor (298) may address compatibility issues, sizing issues to match available resources to those that are to be allocated, and/or other issues to enable bare metal resources to be presented to compute resource sets.

When providing bare metal resources, the composition manager (300) may invoke the functionality of the physical resources manager (302), emulated resources manager (304), and virtual resources manager (306). Consequently, resources may be presented as bare metal resources via pass-through (i.e., forwarding IO from compute resource sets to hardware devices), bare metal resource addressing of virtualized resources, and/or as emulated resources compatible with the hardware components of the compute resource set.

The functionality of the physical resources manager (302), emulated resources manager (304), virtual resources manager (306), and the interception and auditing controller (320) may be invoked using any communication model including, for example, message passing, state sharing, memory sharing, etc.

The system control processor manager (308) may manage the general operation of the system control processor (298). For example, the system control processor manager (308) may operate as an operating system or other entity that manages the resources of the system control processor (298). The composition manager (300), physical resources manager (302), emulated resources manager (304), virtual resources manager (306), and the interception and auditing controller (320) and/or other entities hosted by the system control processor (298) may call or otherwise utilize the system control processor manager (308) to obtain appropriate resources (e.g., processing resources, memory resources, storage, communications, etc.) to provide their functionalities.

The hardware resource services (310) may facilitate use of the hardware components of any number of hardware resource sets (e.g., 110, FIG. 1.1). For example, the hardware resource services (310) may include driver functionality to appropriately communicate with the hardware devices of hardware resource sets. The hardware resource services (310) may be invoked by, for example, the system control processor manager (308).

When providing their functionalities, any of the aforementioned components of the system control processor (298) may perform all, or a portion, methods illustrated in FIGS. 5.1 - 5.3.

The system control processor (298) may be implemented using computing devices. The computing devices may be, for example, an embedded computing device such a system on a chip, a processing device operatively coupled to memory and storage, or another type of computing device. The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the system control processor (298) described in this application and/or all, or a portion, of the methods illustrated in FIGS. 5.1 - 5.3. The system control processor (298) may be implemented using other types of computing devices without departing from the invention. For additional details regarding computing devices, refer to FIG. 7.

In one or more embodiments of the invention, the system control processor (298) is implemented as an on-board device. For example, the system control processor (298) may be implemented using a chip including circuitry disposed on a circuit card. The circuit card may also host the compute resource sets and/or hardware resource sets managed by the system control processor (298).

In one or more embodiments of the invention, the composition manager (300), physical resources manager (302), emulated resources manager (304), virtual resources manager (306), interception and auditing controller (320), system control processor manager (308), and/or hardware resource services (310) are implemented using a hardware device including circuitry. The hardware device may be, for example, a digital signal processor, a field programmable gate array, or an application specific integrated circuit. The circuitry may be adapted to cause the hardware device to perform the functionality of the composition manager (300), physical resources manager (302), emulated resources manager (304), virtual resources manager (306), interception and auditing controller (320), system control processor manager (308), and/or hardware resource services (310). The composition manager (300), physical resources manager (302), emulated resources manager (304), virtual resources manager (306), interception and auditing controller (320), system control processor manager (308), and/or hardware resource services (310) may be implemented using other types of hardware devices without departing from the invention.

In one or more embodiments of the invention, the composition manager (300), physical resources manager (302), emulated resources manager (304), virtual resources manager (306), interception and auditing controller (320), system control processor manager (308), and/or hardware resource services (310) are implemented using a processor adapted to execute computing code stored on a persistent storage (e.g., as part of the system control processor (298) or operatively connected to the system control processor (298) thereby enabling processors of the system control processor (298) to obtain and execute the computing code) that when executed by the processor performs the functionality of the composition manager (300), physical resources manager (302), emulated resources manager (304), virtual resources manager (306), interception and auditing controller (320), system control processor manager (308), and/or hardware resource services (310). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

In one or more embodiments disclosed herein, the storage (312) is implemented using physical devices that provide data storage services (e.g., storing data and providing copies of previously stored data). The devices that provide data storage services may include hardware devices and/or logical devices. For example, storage (312) may include any quantity and/or combination of memory devices (i. e., volatile storage), long term storage devices (i.e., persistent storage), other types of hardware devices that may provide short term and/or long term data storage services, and/or logical storage devices (e.g., virtual persistent storage/virtual volatile storage).

For example, storage (312) may include a memory device (e.g., a dual in line memory device) in which data is stored and from which copies of previously stored data are provided. In another example, storage (312) may include a persistent storage device (e.g., a solid-state disk drive) in which data is stored and from which copies of previously stored data is provided. In a still further example, storage (312) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (312) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (312) may store data structures including, for example, composed information handling system data (314), a resource map (316) and interception and auditing information (318). Each of these data structures is discussed below.

The composed information handling system data (314) may be implemented using one or more data structures that includes information regarding composed information handling systems. For example, the composed information handling system data (314) may specify identifiers of composed information handling systems and resources that have been allocated to the composed information handling systems.

The composed information handling system data (314) may also include information regarding the operation of the composed information handling systems. The information may include, for example, workload performance data, resource utilization rates over time, and/or other information that may be utilized to manage the operation of the composed information handling systems.

The composed information handling system data (314) may further include information regarding management models employed by system control processors. For example, the composed information handling system data (314) may include information regarding duplicative data stored for data integrity purposes, redundantly performed workloads to meet high availability service requirements, encryption schemes utilized to prevent unauthorized access of data, etc.

The composed information handling system data (314) may be maintained by, for example, the composition manager (300). For example, the composition manager may add, remove, and/or modify information included in the composed information handling system data (314) to cause the information included in the composed information handling system data (314) to reflect the state of the composed information handling systems.

The data structures of the composed information handling system data (314) may be implemented using, for example, lists, tables, unstructured data, databases, etc. While illustrated in FIG. 3 as being stored locally, the composed information handling system data (314) may be stored remotely and may be distributed across any number of devices without departing from the invention.

The resource map (316) may be implemented using one or more data structures that include information regarding resources of the information handling system and/or other information handling systems. For example, the resource map (316) may specify the type and/or quantity of resources (e.g., hardware devices, virtualized devices, etc.) available for allocation and/or that are already allocated to composed information handling systems. The resource map (316) may be used to provide data to management entities such as system control processor managers.

The data structures of the resource map (316) may be implemented using, for example, lists, tables, unstructured data, databases, etc. While illustrated in FIG. 3 as being stored locally, the resource map (316) may be stored remotely and may be distributed across any number of devices without departing from the invention.

The resource map (316) may be maintained by, for example, the composition manager (300). For example, the composition manager (300) may add, remove, and/or modify information included in the resource map (316) to cause the information included in the resource map (316) to reflect the state of the information handling system and/or other information handling systems.

The interception and auditing information (318) may be implemented using one or more data structures that includes information generated by the system control processor (298) during the performance of interception and auditing services. The interception and auditing information (318) may include for example, copies of communications facilitated by network interface cards, copies of data stored in storage devices, copies of log information associated with the performance of workloads, etc. The interception and auditing information (318) may include other and/or additional information associated with the performance of interception and auditing services without departing from the invention.

The interception and auditing information (318) may be maintained by the interception and auditing controller (320) of the system control processor (298). The interception and auditing controller (320) may obtain, generate and/or update the interception and auditing information (318) during the performance of interception and auditing services associated with the composed information handling system. The interception and auditing controller (320) may store the interception and auditing information (318) in the storage (312). The system control processor (298) may provide the interception and auditing information (318) to the system control processor manager (50, FIG. 1.1) which may further provide the interception and auditing manager to users (e.g., system administrators, law enforcement officials, etc.). The interception and auditing information (318) may be used by users to determine whether a composed information handling system is being used to perform nefarious activities. The interception and auditing information (318) may be used for other and/or additional purposes without departing from the invention.

The data structures of the interception and auditing information (318) may be implemented using, for example, lists, tables, unstructured data, databases, etc. While illustrated in FIG. 3 as being stored locally, the interception and auditing information (318) may be stored remotely and may be distributed across any number of devices without departing from the invention.

While illustrated in FIG. 3 as being stored locally on the storage (312) of the system control processor (298), the composed information handling system data (314), resource map (316), and the interception and auditing information (318) may be stored remotely and may be distributed across any number of devices including storage devices of the hardware resource set of the composed system without departing from the invention.

While the storage (312) has been illustrated and described as including a limited number and type of data, a storage in accordance with embodiments of the invention may store additional, less, and/or different data without departing from the invention.

While the system control processor (298) has been illustrated and described as including a limited number of specific components, a system control processor in accordance with embodiments of the invention may include additional, fewer, and/or different components without departing from the invention.

As discussed above, a system control processor manager may cooperate with system control processors of control resource sets to instantiate composed information handling systems by presenting computing resources from hardware resource sets to processors of compute resource sets. FIG. 4 shows a diagram of the system control processor manager (50) in accordance with one or more embodiments of the invention.

The system control processor manager (50) may manage the process of instantiating composed information handling systems. To do so, the system control processor manager (50) may include an infrastructure manager (402), an interception and auditing manager (404), and storage (410). Each of these components is discussed below.

The infrastructure manager (402) may provide composition services. Composition services may include obtaining composition requests for composed information handling systems, determining the resources to allocate to instantiate composed information handling systems, and cooperating with system control processors to allocate the identified resources. By doing so, the infrastructure manager (402) may cause any number of computer implemented services to be provided using the composed information handling systems.

To determine the resources to allocate to composed information handling systems, the infrastructure manager (402) may employ an intent based model that translates an intent expressed in a composition request to one more allocations of computing resources. For example, the infrastructure manager (402) may utilize an outcome based computing resource requirements lookup table (414) to match an expressed intent to resources to be allocated to satisfy that intent. The outcome based computing resource requirements lookup table (414) may specify the type, quantity, method of management, and/or other information regarding any number of computing resources that when aggregated will be able to satisfy a corresponding intent. The infrastructure manager (402) may identify resources for allocation to satisfy composition requests via other methods without departing from the invention.

To cooperate with the system control processors, the infrastructure manager (402) may obtain telemetry data regarding the computing resources of any number of information handling systems and/or external resources that are available for allocation. The infrastructure manager (402) may aggregate this data in a telemetry data map (412) which may be subsequently used to identify resources of any number of information handling systems and/or external resources to satisfy composition requests (e.g., instantiate one or more composed information handling systems to meet the requirements of the composition requests).

When the infrastructure manager (402) identifies the computing resources to be allocated, the infrastructure manager (402) may communicate with any number of system control processors to implement the identified allocations. For example, the infrastructure manager (402) may notify a system control processor of a control resource set that portions of a hardware resource set are to be allocated to a compute resource set to instantiate a composed information handling system. The system control processor may then take action (e.g., prepare the portion of the hardware resource set for presentation to a processor of the compute resource set) in response to the notification.

As composed information handling systems are instantiated, the infrastructure manager (402) may add information reflecting the resources allocated to composed information handling systems, the workloads being performed by the composed information handling systems, user identifiers (e.g., a unique combination of bits associated with a particular user) associated with one or more users using the composed information handling systems, and/or other types of information to a composed infrastructure map (416). The infrastructure manager (402) may utilize this information to, for example, decide whether computing resources should be added to or removed from composed information handling system. Consequently, computing resources may be dynamically re-provisioned over time to meet changing workloads imposed on composed information handling systems.

The system control processor manager (50) may fail and/or otherwise lose the telemetry data map (412) and the composed infrastructure map (416) for any reason without departing from the invention. To continue to provide composition services, the system control processor manager (50) may restore the telemetry data map (412) and the composed infrastructure map (416) by performing a discovery to obtain telemetry data from system control processors and obtaining state information associated with the composed systems from one or more system control processors. The system control processor manager (50) may use the telemetry data and the state information to repopulate the telemetry data map (412) and the composed infrastructure map (416) and to determine whether any composed information handling systems need to be re-composed.

In one or more embodiments of the invention, the infrastructure manager (402) is implemented using a hardware device including circuitry. The hardware device may be, for example, a digital signal processor, a field programmable gate array, or an application specific integrated circuit. The circuitry may be adapted to cause the hardware device to perform the functionality of the infrastructure manager (402). The infrastructure manager (402) may be implemented using other types of hardware devices without departing from the invention.

In one or more embodiments of the invention, the infrastructure manager (402) is implemented using a processor adapted to execute computing code stored on a persistent storage that when executed by the processor performs the functionality of the infrastructure manager (402). The processor may be a hardware processor including circuitry such as, for example, a central processing unit or a microcontroller. The processor may be other types of hardware devices for processing digital information without departing from the invention.

When providing its functionality, the infrastructure manager (402) may perform all, or a portion, of the methods illustrated in FIGS. 5.1 - 5.3.

The interception and auditing manager (404) may provide interception and auditing management services. The interception and auditing management services may include: (i) obtaining requests to perform interception and auditing services from users, (ii) identifying an interception an auditing intent associated with the interception and auditing requests, (iii) determining whether users are authorized to request to perform the interception and auditing intent, and (iv) setting up interception and auditing services based on the interception and auditing intent, (v) initiating performance of the interception and auditing services to satisfy the interception and auditing requests, (vi) obtaining interception and auditing information from system control processors (e.g., 298), and (vii) providing interception and auditing information to users. The interception and auditing management services may include other and/or additional services without departing from the invention. The interception and auditing manager (404) may perform other and/or additional services without departing from the invention.

To determine the interception and auditing services to set up to satisfy the interception and auditing requests, the interception and auditing manager (404) may employ an intent based model that translates an interception and auditing intent expressed in an interception and auditing request to one more interception and auditing services. For example, the interception and auditing manager (404) may utilize an interception and auditing policy and function repository (420) to match an expressed intent to interception and auditing policies, interception and auditing function and/or commands, and interception and auditing zones to satisfy that interception and auditing intent. The interception and auditing manager (404) may identify determine the interception and auditing services to setup to satisfy interception and auditing requests via other methods without departing from the invention.

The interception and auditing policy and function repository (420) may be one or more data structures that include information that may be used by the interception and auditing manager (404) of the system control processor manager (50) to set up interception and auditing services as discussed above. The interception and auditing policy and function repository (420) may include a list of interception and auditing intents, interception and auditing policies, interception and auditing function and/or commands, and interception and auditing zones. The interception and auditing policy and function repository (420) may include other and/or additional information without departing from the invention. Each of the aforementioned components of the interception and auditing policies is discussed below.

The interception and auditing policies may be one or more data structures that specify requirements for satisfying an interception and auditing intent. Each interception and auditing policy may be associated with an interception and auditing intent. The requirements may include, for example, a schedule for performing interception and auditing services, a retention period for interception and auditing information, a schedule for providing interception and auditing information to the system control processor manager and/or the user associated with the interception and auditing request, types of interception and auditing services to perform, etc. The requirements may include other and/or additional types of requirements associated with the interception and auditing services without departing from the invention. The interception and auditing policies may include other and/or additional information without departing from the invention.

The interception and auditing functions and/or commands may be one or more data structures that include one or more sets of computing instructions (e.g., binaries, libraries, application images, etc.) and/or commands (e.g., application programming interface calls) that, when executed, result in the performance of interception and auditing services. Each interception and auditing functions and/or commands may be associated with an interception and auditing policy and one or more interception and auditing zones. The system control processor may provide the interception and auditing functions and/or commands to a system control processor, which may translate and execute the interception and auditing functions and/or commands to perform interception and auditing services. The interception and auditing functions and/or commands may include other and/or additional information without departing from the invention.

The interception and auditing zones may be one or more data structures that specify one or more components of composed information handling systems for which interception and auditing services are to be performed. An interception and auditing zone may include, for example, a list of component identifiers associated with any number of hardware resources of one or more hardware resource sets and processors and memory of one or more compute resource sets. The interception and auditing zones may prevent the performance of interception and auditing services on components of composed information handling system that are not relevant to the performance of interception and auditing services, therefore mitigating overreach in the performance of interception and auditing services. The interception and auditing zones may include other and/or additional information without departing from the invention.

The interception and auditing policy and function repository (420) may further include mappings between the interception and auditing intents, the interception and auditing policies, the interception and auditing zones, and the interception and auditing functions and/or commands. Such mappings may indicate which components (e.g., interception and auditing intent) of the interception and auditing policy and function repository (420) are associated with other components (e.g., interception and auditing policies, interception and auditing zones, and interception and auditing functions and/or commands) of the interception and auditing policy and function repository (420). The interception and auditing manager (404) may use such mappings to setup interception and auditing services based on an interception and auditing intent to satisfy an interception and auditing request.

The system control processor manager (50) may update interception and auditing policy and function repository (420) based on requests by authorized users. The interception and auditing policy and function repository (420) may be updated to add, remove, and/or modify interception and auditing policy intents, interception and auditing policies, interception and auditing functions and/or commands, and interception and auditing zones. The interception and auditing policy and function repository (420) may also be updated to add, remove, and/or modify mapping between interception and auditing policy intents, interception and auditing policies, interception and auditing functions and/or commands, and interception and auditing zones. In one or more embodiments of the invention, the updates to the interception and auditing policy and function repository (420) made by authorized users may be transparent (i.e., unknown) to other users of composed information handling systems. As a result, authorized users (e.g., law enforcement officials, system administrators, etc.) may be able to add, modify, and/or remove interception and auditing capabilities to the system control processor manager (50) without the knowledge of the other users.

To determine whether a user is authorized to request a particular interception and auditing intent, to update the interception and auditing policy and function repository (420), and/or to update the interception and auditing access information (418), the interception and auditing manager (404) may use the interception and auditing access information (418). The interception and auditing access information (418) may specify a list of users and another list of interception and auditing intents, which may include intents to update the interception and auditing policy and function repository (420) and/or and the interception and auditing access information (418), associated with each user that each user is authorized to request to perform. The interception and auditing access information (418) may include other and/or additional information without departing from the invention.

In one or more embodiments of the invention, the interception and auditing manager (404) is implemented using a hardware device including circuitry. The hardware device may be, for example, a digital signal processor, a field programmable gate array, or an application specific integrated circuit. The circuitry may be adapted to cause the hardware device to perform the functionality of the interception and auditing manager (404). The interception and auditing manager (404) may be implemented using other types of hardware devices without departing from the invention.

In one or more embodiments of the invention, the interception and auditing manager (404) is implemented using a processor adapted to execute computing code stored on a persistent storage that when executed by the processor performs the functionality of the interception and auditing manager (404). The processor may be a hardware processor including circuitry such as, for example, a central processing unit or a microcontroller. The processor may be other types of hardware devices for processing digital information without departing from the invention.

When providing its functionality, the interception and auditing manager (404) may perform all, or a portion, of the methods illustrated in FIGS. 5.1 - 5.3.

In one or more embodiments disclosed herein, the storage (410) is implemented using physical devices that provide data storage services (e.g., storing data and providing copies of previously stored data). The devices that provide data storage services may include hardware devices and/or logical devices. For example, storage (410) may include any quantity and/or combination of memory devices (i. e., volatile storage), long term storage devices (i.e., persistent storage), other types of hardware devices that may provide short term and/or long term data storage services, and/or logical storage devices (e.g., virtual persistent storage/virtual volatile storage).

For example, storage (410) may include a memory device (e.g., a dual in line memory device) in which data is stored and from which copies of previously stored data are provided. In another example, storage (410) may include a persistent storage device (e.g., a solid-state disk drive) in which data is stored and from which copies of previously stored data is provided. In a still further example, storage (410) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (410) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (410) may store data structures including, for example, the telemetry data map (412), outcome based computing resource requirements lookup table (414), the composed infrastructure map (416), the interception and auditing access information (418), and the interception and auditing policy and function repository (420). These data structures may be maintained by, for example, the infrastructure manager (402) and/or the interception and auditing manager (404). For example, the infrastructure manager (402) and/or the interception and auditing manager (404) may add, remove, and/or modify information included in these data structures to cause the information included in these data structure to reflect the state of any number of information handling systems, external resources, and/or composed information handling systems.

Any of these data structures may be implemented using, for example, lists, tables, unstructured data, databases, etc. While illustrated in FIG. 4 as being stored locally, any of these data structures may be stored remotely and may be distributed across any number of devices without departing from the invention.

While the storage (410) has been illustrated and described as including a limited number and type of data, a storage in accordance with embodiments of the invention may store additional, less, and/or different data without departing from the invention.

While the system control processor manager (50) has been illustrated and described as including a limited number of specific components, a system control processor manager in accordance with embodiments of the invention may include additional, fewer, and/or different components than those illustrated in FIG. 4 without departing from the invention.

As discussed above, the system of FIG. 1.1 may provide computer implemented services using composed information handling systems. FIGS. 5.1-5.3 show methods that may be performed by components of the system of FIG. 1.1 to compose and manage composed information handling systems.

Turning to FIG. 5.1, FIG. 5.1 shows a flowchart of a method in accordance with one or more embodiments of the invention. The method depicted in FIG. 5.1 may be performed to instantiate a composed information handling system in accordance with one or more embodiments of the invention. The method shown in FIG. 5.1 may be performed by, for example, a system control processor manager (e.g., 50, FIG. 1.1). Other components of the system in FIG. 1.1 may perform all, or a portion, of the method of FIG. 5.1 without departing from the invention.

While FIG. 5.1 is illustrated as a series of steps, any of the steps may be omitted, performed in a different order, additional steps may be included, and/or any or all of the steps may be performed in a parallel and/or partially overlapping manner without departing from the invention.

In step 500, a composition request for a composed information handling system is obtained. The composition request may be obtained using any method without departing from the invention. For example, the composition request may be obtained as part of a message from another entity operatively connected to a system control processor manager. In another example, the composition request may be locally stored in a storage of a system control processor manager.

The composition request may be a data structure specifying that the composed information handling system is to be instantiated. As discussed with respect to FIG. 3, the composition request may be specific (i.e., includes a listing of resources to be allocated to the composed information handling system) or intent based (i.e., a desired outcome without specifying the resources to be allocated). The composition request may include any type and quantity of information usable to determine how to instantiate a composed information handling system.

In one or more embodiments of the invention, the composition request includes a list of computing resources to be allocated to the composed information handling system. For example, the composition request may specify computing resources, memory resources, storage resources, graphics processing resources, compute acceleration resources, communications resources, etc. The list may include any type and quantity of computing resources. The list of computing resources may include computing resources to be used to provide data protection services.

In one or more embodiments of the invention, the composition request specifies how the computing resources are to be presented. For example, the composition request may specify virtualization, emulation, etc. for presenting the computing resources.

In one or more embodiments of the invention, the composition request specifies how the resources used to present the computing resources are to be managed (e.g., a management model such as data integrity, security, management, usability, performance, etc.). For example, the composition request may specify levels of redundancy for data storage, data integrity to be employed (e.g., redundant array of independent disks (RAID), error correction code (ECC), etc.), levels of security to be employed for resources (e.g., encryption), and/or other information that specifies how system control processors are to utilize resources for presentation of resources to composed information handling systems. The composition request may specify that data protection services are to be provided to the computing resources of the composed information handling system. The data protection services may include performing deduplication and/or compression on data generated by applications executing in the composed information handling system. The methods employed by the system control processors, or a portion thereof, may be transparent to the composed information handling systems because the resources may be presented to the compute resource sets of the composed information handling systems as bare metal resources while the system control processors provide the management functionality.

In one or more embodiments of the invention, the composition request includes a list of applications to be hosted by the composed information handling system. The list may include any type and quantity of applications.

The composition request may also specify the identities of one or more system control processors hosted by other devices. In some scenarios, as noted above, resources from other information handling systems may be used to form a composed information handling system. The identifiers of the system control processors of these other information handling systems may be used to form operable connections between the system control processors. These connections may be used by the system control processors to present, as bare metal resources, computing resources from other information handling systems to compute resource set(s) of the composed information handling system.

In one or more embodiments of the invention, the composition request specifies a desired outcome. The desired outcome may be, for example, computer implemented services to be provided in response to the composition request. In another example, the desired outcome may be a list of applications to be hosted in response to the composition request. In other words, the composition request may specify a desired outcome without specifying the resources that are to be used to satisfy the requests, the methods of managing the resources, models employed to provide for data protection/integrity/security/etc. Such a composition request may be referred to as an intent based composition request.

In step 502, at least one compute resource set having computing resources specified by the composition request is identified. The at least one compute resource set may be identified by matching the computing resources specified by the composition request to at least one compute resource set having those resources using a telemetry data map (412, FIG. 4).

For example, the telemetry data map (412, FIG. 4) may specify a list of compute resource sets, identifiers of control resource sets that manage the listed compute resource sets, the hardware devices of the listed compute resource sets, and characteristics and information regarding the compute resource set (e.g., memory size, storage size). By matching the computing resources specified by the composition request to the hardware devices specified in the list, the compute resource set corresponding to the listed hardware devices may be identified as the at least one compute resource set.

If no compute resource set includes all of the computing resources specified by the composition request, multiple compute resource sets having sufficient hardware devices to meet the computing resources specified by the composition request may be identified as the at least one compute resource set.

In step 504, at least one hardware resource set having hardware resources specified by the composition request is identified. The at least one hardware resource set may be identified similarly to that described with respect to the identified of the at least one compute resource set of step 502. For example, the computing resources requirements specified by the composition request may be matched to compute resource sets.

In step 506, management services for managing components of the composed system are setup using at least one control resource set to obtain logical hardware resources managed by the at least one control resource set. Additional management services may also be set up. The additional management services may include, for example, virtualization, emulation, abstraction, indirection, duplicative writes, deduplication, compression, backup generation, and/or other type of services to meet the requirements of data integrity, security, and/or management models. The control resource set may provide at least a portion of the management services to the at least one hardware resource set identified in step 506.

In step 508, the logical hardware resources are presented to the at least one compute resource set as bare metal resources using the at least one control resource set to instantiate the composed information handling system to service the composition request.

To present the logical hardware resources, the system control processor manager may instruct the system control processors of the at least one control resource set to make the bare metal resources discoverable. For example, the at least one control resource set may send a bare metal communication to one or more processors of the at least one compute resource set to cause the processors to discover the presence of the presented bare metal resources. By doing so, the processors may then begin to utilize the logical hardware resources as bare metal resources resulting in a composed information handling system having all of the resources necessary to provide desired computer implemented services.

The method may end following step 508.

Using the method illustrated in FIG. 5.1, a composed information handling system may be formed using computing resources from one or more information handling systems and/or external resources.

Following step 508 of FIG. 5.1, no applications may be presently executing on the composed information handling system. The composed information handling systems may then be turned over to other entities for management (e.g., orchestrators) or may be additionally managed by the system control processor manager by instructing the system control processors to load applications onto the composed information handling systems using any method without departing from the invention. For example, device images (e.g., data structures including information that may be used to instantiate one or more applications in corresponding operating states) may be used to begin execution of appropriate applications in desired states. By doing so, the composed information handling systems may begin to provide desired computer implemented services. Applications may be instantiated on a composed information handling system using other methods (e.g., performing first-time installations, copying binaries to storage and beginning execution of the binaries, etc.) without departing from the invention.

Concurrently with or following the steps illustrated in FIG. 5.1, the composed information handling system data (314, FIG. 3) and resource map (316, FIG. 3) may be updated to reflect that various resources have now been allocated and are no longer available for allocation. For example, the resource map (316, FIG. 3) may be updated to indicate that the various hardware/virtualized devices being utilized to present bare metal resources to the composed information handling system are now allocated and unavailable (at least in part if virtualized) for allocation to present bare metal resources to other composed information handling systems. The resource maps maintained by the system control processor manager may be similarly updated.

Turning to FIG. 5.2, FIG. 5.2 shows a flowcharts of a method in accordance with one or more embodiments of the invention. The method of FIG. 5.2 may be performed to manage interception and auditing services in accordance with one or more embodiments of the invention. The method shown in FIG. 5.2 may be performed by, for example, a system control processor manager (e.g., 50, FIG. 1.1). Other components of the system in FIG. 1.1 may perform all, or a portion, of the methods of FIG. 5.2 without departing from the invention.

While FIG. 5.2 is illustrated as a series of steps, any of the steps may be omitted, performed in a different order, additional steps may be included, and/or any or all of the steps may be performed in a parallel and/or partially overlapping manner without departing from the invention.

In step 510, a request to perform interception and auditing is obtained from a user. The interception and auditing request may be obtained using any method without departing from the invention. For example, the interception and auditing request may be obtained as part of a message from another entity operatively connected to a system control processor manager (e.g., a client operated by a user). In another example, the composition request may be locally stored in a storage of a system control processor manager by a user.

The interception and auditing request may be a data structure (e.g., a manifest) specifying that one or more interception and auditing services is to be performed. The interception and auditing request may include a user identifier, one or more target user identifiers, and/or one or more target composed information handling system identifiers. The user identifiers may be used by the system control processor manager to identify the user that submitted the interception and auditing request. The target composed information handling system identifiers may be used to identify the composed information handling systems on which the interception and auditing services are to be performed. The target user identifier may specify a user of one or more composed information handling systems for which interception and auditing services are to be performed. The interception and auditing request may further include an interception and auditing intent specifying the interception and auditing services to be performed. The interception and auditing request may include other and/or additional information usable to manage interception and auditing services for composed information handling systems without departing from the invention.

In step 512, an interception and auditing intent associated with the request is identified. As discussed above, the interception and auditing request may include an interception and auditing intent. The interception and auditing intent may specify a desired outcome without specifying particular actions to be taken, data to be collected, and/or resources to associate with the interception and auditing request. The desired outcome may be, for example, monitor for insider trading, intercept communications, check data storage, and/or other types of desired outcomes associated with interception and auditing. In other words, the interception and auditing request may specify a desired outcome without specifying the resources that are to be used to satisfy the request, the methods for performing interception and auditing services to satisfy the desired outcomes, and/or models employed to provide for inferencing/indexing/security/etc. to satisfy the desired outcome.

In one or more embodiments of the invention, the interception and auditing intent may include updating the interception and auditing access information and/or updating the interception and auditing policy and function repository.

The system control processor manager may parse the interception and auditing request to identify the interception and auditing intent. The system control processor manager may include a list of interception and auditing intents and may compare the interception and auditing intent included in the interception and auditing request to identify the interception and auditing intent associated with the interception and auditing intent. The interception and auditing intent associated with the interception and auditing request may be identified via other and/or additional methods without departing from the invention.

In step 514, a determination is made as to whether the user is authorized to request the interception and auditing intent. In one or more embodiments of the invention, the system control process manager uses interception and auditing access information to determine whether the user is authorized to request the interception and auditing intent. As discussed above, the interception and auditing access information may include a list of user identifiers associated with user that are authorized to request to perform interception and auditing services for composed information handling systems. Each user identifier may be further associated with one or more interception and auditing intents that the corresponding user is authorized to request.

To determine whether the user is authorized to request the interception and auditing intent, the system control processor may compare the user identifier included in the interception and auditing request with the list of user identifiers included in the interception and auditing access information. If the user identifier included in the interception and auditing request does not match a user identifier included in the interception and auditing access information, then the system control processor manager may determine that the user is not authorized to request the interception and auditing intent. If the user identifier is included in the interception and auditing access information, then the system control processor manager may further compare the interception and auditing intent included in the interception and auditing request with the interception and auditing intents associated with the user identifier included in the interception and auditing access information.

If the interception and auditing intent included in the interception and auditing request matches an interception and auditing intent associated with the user identifier included in the interception and auditing access information, then the system control processor manager may determine that the user is authorized to request the interception and auditing intent. If the interception and auditing intent included in the interception and auditing request does not match an interception and auditing intent associated with the user identifier included in the interception and auditing access information, then the system control processor manager may determine that the user is not authorized to request the interception and auditing intent. The determination as to whether the user is authorized to request the interception and auditing intent may be made via other and/or additional methods without departing from the invention.

In one or more embodiments of the invention, if it is determined that the user is authorized to request the interception and auditing intent, then the method proceeds to step 516. In one or more embodiments of the invention, if it is determined that the user is not authorized to request the interception and auditing intent, then the method proceeds to step 526.

In step 516, a composed system associated with the request is identified. In one or more embodiments of the invention, the system control processor uses the interception and auditing request to identify the composed system associated with the interception and auditing request. As discussed above, the interception and auditing system may include one or more target composed information handling system identifiers associated with one or more composed information handling systems which the interception and auditing request targets. The system control processor manager may parse the interception and auditing request to identify the target composed system identifier. On the other hand, the interception and auditing request may include one or more target user identifiers associated with one or more users which the interception and auditing request targets. The system control processor manager may parse the interception and auditing request to identify the one or more target user identifiers. The system control processor manager may identify composed information handling systems associated with the target user identifiers using the composed infrastructure map. The composed infrastructure map may specify user identifiers and composed information handling systems associated with user identifiers. The composed system associated with the request may be identified via other and/or additional methods without departing from the invention.

In one or more embodiments of the invention, if the interception and auditing intent includes updating the interception and auditing access information and/or updating the interception and auditing policy and function repository, then the system control processor updates the interception and auditing access information and/or updating the interception and auditing policy and function repository. The interception and auditing request may include instructions for updating the interception and auditing access information and/or updating the interception and auditing policy and function repository. The interception and auditing request may include copies of interception and auditing access information, interception and auditing policies, interception and auditing functions and/or commands, and/or interception and auditing zones to use to update the interception and auditing access information and/or the interception and auditing policy and function repository. The system control processor manager may update the interception and auditing access information and/or interception and auditing policy and function repository using the interception and auditing request. The system control processor manager may update the interception and auditing access information and/or interception and auditing policy and function repository via other and/or additional methods without departing from the invention. If the interception and auditing intent only included updating the interception and auditing access information and/or updating the interception and auditing policy and function repository, then the method may end following step 516. Otherwise, the method may proceed to step 518.

In step 518, interception and auditing services are setup using an interception and auditing policy and function repository based on the intent. In one or more embodiments of the invention, the system control processor manager uses the interception and auditing policy and function repository to setup interception and auditing services based on the interception and auditing intent. As discussed above, the interception and auditing policy and function repository may include a list of interception and auditing intents. Each interception and auditing intent may be associated with one or more interception and auditing policies also included in the interception and auditing policy and function repository. The interception and auditing policy and function repository may include mappings between the interception and auditing intents and the interception and auditing policies. As discussed above, the interception and auditing policies may specify one or more rules and/or requirements for instantiating the interception and auditing services to satisfy the interception and auditing intent.

Each interception and auditing policy, or portion thereof (e.g., a specific rule and/or requirement), may be associated with one or more interception and auditing functions and/or commands. The interception and auditing policy and function repository may further include mappings between the interception and auditing policies and the interception and auditing functions and/or commands. The interception and auditing policy and function repository may further include interception and auditing zones. Each interception and auditing policy may further be associated with one or more interception and auditing zones. The interception and auditing policy and function repository may include mappings between the interception and auditing policies and the interception and auditing zones.

The system control processor manager may use the aforementioned mappings between the interception and auditing intents and the interception and auditing policies to identify the one or more interception and auditing policies associated with the interception and auditing intent. The system control processor manager may further use the mappings between the identified interception and auditing policies and the interception and auditing functions and/or commands to identify interception and auditing functions and/or commands associated with the interception and auditing policies. The system control processor manager may further use the mappings between the identified interception and auditing policies and the interception and auditing zones to identify interception and auditing zones associated with the interception and auditing policies. As a result, the system control processor manager identifies interception and auditing functions and/or commands and interception and/or auditing zones that may be used to instantiate the interception and auditing services to satisfy the interception and auditing intent. The interception and auditing services may be setup using an interception and auditing policy and function repository based on the interception and auditing intent via other and/or additional methods without departing from the invention.

In step 520, the performance of the interception and auditing services using an at least one control resource set of the composed system is initiated. In one or more embodiments of the invention, the system control processor manager sends a request to initiate the performance of interception and auditing services to a system control processor of the at least one control resource set of the composed information handling system. The request may be sent using any appropriate method of data transmission without departing from the invention. For example, the request may be sent as part of a message as network packets through one or more network devices that operatively connect the system control processor manager to the system control processor. The request may include the interception and auditing functions and/or commands identified in step 518. The request may further include the interception and auditing zones identified in step 518. In response to obtaining the request, the system control processor may execute the interception and auditing functions and/or commands for the interception and auditing zones. As a result, the system control processor and/or other components of the composed information handling system may perform the interception and auditing services. The performance of the interception and auditing services using an at least one control resource set of the composed information handling system may be initiated via other and/or additional methods without departing from the invention.

In step 522, interception and auditing information is obtained from the at least one control resource set. The performance of interception and auditing services may result in the generation of interception and auditing information. A system control processor of the at least one control resource set may send the interception and auditing information to the system control processor manager. The system control processor may send the interception and auditing information to the system control processor manager periodically and/or at the completion of the interception and auditing services. The interception and auditing information may be sent using any appropriate method of data transmission without departing from the invention. For example, the interception and auditing information may be sent as part of a message as network packets through one or more network devices that operatively connect the system control processor to the system control processor manager. The interception and auditing information may be obtained from the at least one control resource set via other and/or additional methods without departing from the invention.

In step 524, the interception and auditing information is provided to the user. The system control processor manager may send the interception and auditing information to the user. The system control processor manager may send the interception and auditing information to the user periodically and/or at the completion of the interception and auditing services. The interception and auditing information may be sent using any appropriate method of data transmission without departing from the invention. For example, the interception and auditing information may be sent as part of a message as network packets through one or more network devices that operatively connect the system control processor manager to the user. The interception and auditing information may be provided to the user via other and/or additional methods without departing from the invention.

The user may perform one or more actions based on the interception and auditing information in response to obtaining the interception and auditing information. The actions may include, for example, do nothing if the interception and auditing information indicates no nefarious activity by the user of the composed information handling system, store the interception and auditing information for future use, notify law enforcement, notify a system administrator, request additional interception and auditing services, and/or other types of actions based on the interception and auditing information without departing from the invention.

In one or more embodiments of the invention, the method ends following step 524.

In step 526, the user is notified of an unauthorized attempt to perform interception and auditing. In one or more embodiments of the invention, the system control processor manager sends a notification to the user. The notification may include a message that indicates that the user is not authorized to request the interception and auditing intent. The notification may be sent using any appropriate method of data transmission without departing from the invention. For example, the notification may be sent as part of a message as network packets through one or more network devices that operatively connect the system control processor manager to the user.

In one or more embodiments of the invention, the system control processor manager may send a second notification to one or more other users (e.g., the system administrator). The second notification may include a message indicating that an unauthorized attempt to request an interception and auditing intent was made. The second notification may further include additional information such as a user identifier associated with the user, communication information (e.g., a network address) associated with the user, a copy of the interception and auditing request, and/or other and/or additional information associated with user that submitted the interception and auditing request and/or the interception and auditing request itself without departing from the invention. The second notification may be sent using any appropriate method of data transmission without departing from the invention. For example, the second notification may be sent as part of a message as network packets through one or more network devices that operatively connect the system control processor manager to the one or more other users. The user may be notified of an unauthorized attempt to perform interception and auditing via other and/or additional methods without departing from the invention.

In one or more embodiments of the invention, the method ends following step 526.

Using the method illustrated in FIG. 5.2, interception and auditing services may be managed. As a result, a user may submit an interception and auditing request, verification that the user is authorized to request the interception and auditing intent is performed, interception and auditing services associated with the interception and auditing intent are set up, and the performance of the interception and auditing services is initiated to satisfy the interception and auditing intent. Such interception and auditing services may be set up and performed without the target user’s and/or the service provider’s knowledge.

Turning to FIG. 5.3, FIG. 5.3 shows a flowcharts of a method in accordance with one or more embodiments of the invention. The method of FIG. 5.3 may be performed to perform interception and auditing services in accordance with one or more embodiments of the invention. The method shown in FIG. 5.2 may be performed by, for example, a system control processor (e.g., 114, FIG. 1.2). Other components of the system in FIG. 1.1 may perform all, or a portion, of the methods of FIG. 5.3 without departing from the invention.

While FIG. 5.3 is illustrated as a series of steps, any of the steps may be omitted, performed in a different order, additional steps may be included, and/or any or all of the steps may be performed in a parallel and/or partially overlapping manner without departing from the invention.

In step 540, a request to perform interception and auditing services from a system control processor manager is obtained. In one or more embodiments of the invention, the system control processor manager sends a request to initiate the performance of interception and auditing services. As discussed above, the request may be sent using any appropriate method of data transmission without departing from the invention. For example, the request may be sent as part of a message as network packets through one or more network devices that operatively connect the system control processor manager to the system control processor. The request to perform interception and auditing services may be obtained from the system control processor manager via other and/or additional methods without departing from the invention.

In step 542, interception and auditing services are performed based on the request to obtain interception and auditing information. As discussed above, the request may include the interception and auditing zones and the interception and auditing functions and/or commands. The interception and auditing functions and/or commands may be translated (e.g., into GenZ or CXL commands) in order to implement the interception and auditing functions and/or commands. The system control processor may execute the interception and auditing function and or commands for the interception and auditing zones (i.e., perform interception and auditing services for a specific portion of the composed information handling system associated with the interception and auditing policy). As a result of executing the interception and auditing functions and/or commands, the system control processor may instantiate the interception and auditing services. The interception and auditing services may then begin execution. The interception and auditing services may be performed via other and/or additional methods without departing from the invention.

The interception and auditing services may include any type of services associated with interception and auditing of one or more components of a composed information handling system without departing from the invention. For example, the interception and auditing services may include monitoring communication between network interface cards, reading all, or a portion of, storage and/or memory devices, searching storage and/or memory device data for particular information, monitoring the performance of workloads by one or more compute resource sets, etc. The performance of interception and auditing services may result in the generation of interception and auditing information (e.g., 318, FIG. 3).

In step 544, the interception and auditing information is provided to the system control processor manager. As discussed above, the performance of interception and auditing services may result in the generation of interception and auditing information (e.g., 318, FIG. 3). For example, the interception and auditing information may include: copies of communications between network interface cards, data read from storage and/or memory devices, logs associated with the performance of workloads by the at least one compute resource set, etc.

In one or more embodiments of the invention, the system control processor of the at least one control resource set may send the interception and auditing information to the system control processor manager. The system control processor may send the interception and auditing information to the system control processor manager periodically and/or at the completion of the interception and auditing services. The interception and auditing information may be sent using any appropriate method of data transmission without departing from the invention. For example, the interception and auditing information may be sent as part of a message as network packets through one or more network devices that operatively connect the system control processor to the system control processor manager. The interception and auditing information may be provided to the system control processor manager via other and/or additional methods without departing from the invention.

In one or more embodiments of the invention, the method ends following step 544.

Using the method illustrated in FIG. 5.3, interception and auditing services may be performed by one or more system control processors for composed information handling systems. As a result, interception and auditing information may be generated through the performance of the interception and auditing services. Additionally, the interception and auditing services may be performed without the target user’s knowledge.

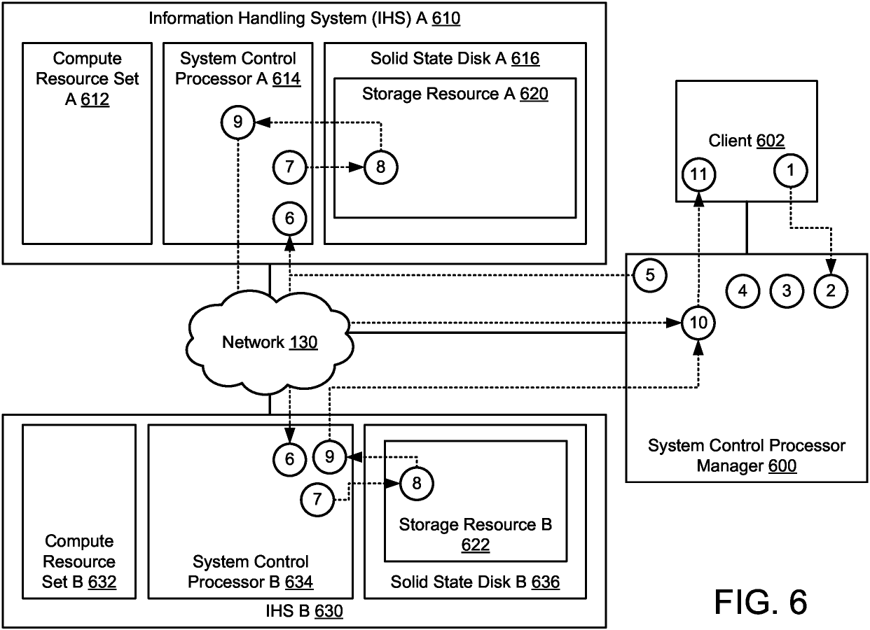

To further clarify embodiments of the invention, a non-limiting example is provided in FIG. 6. FIG. 6 shows a system similar to that illustrated in FIG. 1.1. Actions performed by components of the illustrated system are illustrated by numbered, circular boxes interconnected, in part, using dashed lines. For the sake of brevity, only a limited number of components of the system of FIG. 1.1 are illustrated in FIG. 6.

### EXAMPLE

Consider a scenario as illustrated in FIG. 6.1 in which a user of a client (602), at step 1, sends a request to perform interception and auditing to a system control processor manager (600) that manages interception and auditing services for a composed information handling system including information handling system (IHS) A (610) and IHS B (630). The composed information handling system includes compute resource set A (612), system control processor A (614), and storage resource A (620) of solid state disk A (616) of IHS A (610). The composed information handling system further includes compute resource set B (632), system control processor B (634), and storage resource B (622) of solid state disk B (636) of IHS B (630).

The user of the client (602) may be system administrator that manages IHS A (610) and IHS B (630) and may perform periodic audits of the composed information handling systems that include IHS A (610) and IHS B (630). The request includes the composed information handling system identifier associated with the composed information handling system. The request also includes the user identifier associated with the user of the client (602). At step 2, the system control processor manager (600) parses the interception and auditing request to identify the interception and auditing intent associated with the request. The interception and auditing request includes the interception and auditing intent to perform random storage reads in order to audit the storages of the composed information handling system to check for nefarious activity by the user of the composed information handling system.

At step 3, the system control processor manager (600) uses interception and auditing access information and the user identifier included in the interception and auditing request to determine that the user is authorized to request to the interception and auditing intent to perform random storage reads. The interception and auditing access information includes the user identifier and the user identifier is associated with the interception and auditing intent to perform random storage reads. At step 4, the system control processor manager (600) identifies the composed information handling system associated with the interception and auditing request using the composed information handling system identifier included in the interception and auditing request.

At step 5, the system control processor manager (600) sets up interception and auditing services to satisfy the interception and auditing intent. The system control processor manager (600) uses an interception and auditing policy and function repository to identify an interception and auditing policy associated with the interception and auditing intent of performing random reads of the storages of the composed information handling system. The interception and auditing policy specifies a schedule for performing the random reads, the size of the random reads, a retention period for the interception and auditing information, and a schedule for providing the interception and auditing information to the system control processor manager (600).

The system control processor manager (600) then identifies an interception and auditing zone associated with the interception and auditing policy using mappings between the interception and auditing policies and the interception and auditing zone included in the interception and auditing policy and function repository. The interception and auditing zone specifies storage resource A (620) of solid state disk A (616) of IHS A (610) and storage resource B (622) of solid state disk B (636) of IHS B (630). The system control processor manager (600) then identifies interception and auditing functions and/or commands associated with the interception and auditing policy using mappings between the interception and auditing policies and the interception and auditing functions and/or commands included in the interception and auditing policy and function repository. The interception and auditing functions and/or commands specify instructions for instantiating and performing interception and auditing services to meet the interception and auditing policy requirements and satisfy the interception and auditing intent to perform random reads of the storages of the composed information handling systems.

At step 6, the system control processor manager (600) initiates the performance of the interception and auditing services by sending the interception and auditing zone and the interception and auditing functions and/or commands to system control processor A (614) of IHS A (610) and system control processor B (634) of IHS B (630) based on the interception and auditing zone. At step 7, system control processor A (614) executes the interception and auditing functions and/or commands to perform the interception and auditing services for storage resource A (620). Similarly, system control processor B (634) executes the interception and auditing functions and/or commands to perform the interception and auditing services for storage resource B (622). At step 8, system control processor A (614) performs reads of random portions of storage resource A (620) to obtain a first portion of the interception and auditing information associated with storage resource A (620). Likewise, system control processor B (634) performs reads of random portions of storage resource B (622) to obtain a second portion of the interception and auditing information associated with storage resource B (622).

At step 9, system control processor A (614) stores the first portion of the interception and auditing information in local storage. Similarly, system control processor B (634) stores the second portion of the interception and auditing information in local storage. At step 10, system control processor A (614) and system control processor B (634) provide the first and second portion of the interception and auditing information to the system control processor manager (600). At step 11, the system control processor manager (600) provides the interception and auditing information to the user of the client (602). The user may inspect the interception and auditing information to determine whether the interception and auditing information indicates that the user of the composed information handling system is engaged in any nefarious activities.

### END OF EXAMPLE

Thus, as illustrated in FIG. 6, embodiments of the invention may provide a system that enables the performance of interception and auditing services of composed information handling systems without the knowledge of the users of the composed information handling systems.

As discussed above, embodiments of the invention may be implemented using computing devices. FIG. 7 shows a diagram of a computing device in accordance with one or more embodiments of the invention. The computing device (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), input devices (710), output devices (708), and numerous other elements (not shown) and functionalities. Each of these components is described below.

In one embodiment of the invention, the computer processor(s) (702) may be an integrated circuit for processing instructions. For example, the computer processor(s) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (not shown) (e.g., a local area network (LAN), a wide area network (WAN) such as the Internet, mobile network, or any other type of network) and/or to another device, such as another computing device.

In one embodiment of the invention, the computing device (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

Embodiments of the invention may provide a system and method for performing interception and auditing services for composed information handling systems. Specifically, embodiments of the invention may enable users to submit interception and auditing requests associated with a particular interception and auditing intent, provide a system control processor manager that may verify the authorization of user to request the interception and auditing intents, setup interception and auditing services to satisfy the interception and auditing intent, and to perform the interception and auditing services without the involvement or knowledge of target users of the composed information handling systems. Consequently, even though the resulting composed information handling systems may be used by target users, interception and auditing services may be performed to identify and track nefarious activities of the target users without the knowledge or tampering of the interception and auditing services by the target users.

Thus, embodiments of the invention may address the problem of the use of composed information handling system to perform nefarious activities. For example, by utilizing a system control processor manager to setup interception and auditing services performed by system control processors, the performance of nefarious activities may be identified and tracked without the knowledge such interception and auditing services by the target users.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for performing interception and auditing services for composed information handling systems, comprising:
obtaining, by a system control processor manager, a request to perform interception and auditing from a user; and
in response to obtaining the request:
identifying, by the system control processor manager, an interception and auditing intent associated with the request;
making a determination, by the system control processor manager, that the user is authorized to perform the interception and auditing intent;
in response to the determination:
identifying, by the system control processor manager, a composed system associated with the request;
setting up, by the system control processor manager, interception and auditing services using an interception and auditing policy and function repository based on the intent; and
initiating, by the system control processor manager, performance of the interception and auditing services using an at least one control resource set of the composed system.

2. The method of claim 1, wherein the at least one control resource set comprises a system control processor.

3. The method of claim 2, wherein performing the interception and auditing services by the system control processor is transparent to a target user of the composed information handling system.

4. The method of claim 3, further comprising:
after initiating the performance of the interception and auditing services using the at least one control resource set of the composed system:
obtaining, by the system control processor, a request to perform the interception and auditing services;
performing, by the system control processor, the interception and auditing services to obtain interception and auditing information; and
providing, by the system control processor, the interception and auditing information to the system control processor manager.

5. The method of claim 4, further comprising:
after providing, by the system control processor, the interception and auditing information to the system control processor manager:
providing, by the system control processor manager, the interception and auditing information to the user.

6. The method of claim 1, wherein the interception and auditing policy and function repository comprises:
an interception and auditing policy; and
interception and auditing function mappings.

7. The method of claim 6, wherein setting up interception and auditing services comprises:
identifying the interception and auditing policy associated with the interception and auditing intent using the interception and auditing policy and function repository;
identifying functions associated with the interception and auditing policy using the interception and auditing function mappings; and
wherein performance of the interception and auditing services comprises executing at least one of the functions within an interception and auditing zone on the at least one control resource set, wherein the interception and auditing zone is associated with the interception and auditing intent.

8. The method of claim 1, wherein making the determination that the user is authorized to perform the interception and auditing intent comprises:
identifying a user identifier associated with the user included in interception and auditing access information; and
determining that the user identifier is associated with the intent.

9. A non-transitory computer readable medium comprising computer readable program code, which when executed by a computer processor enables the computer processor to perform a method for performing interception and auditing services for composed information handling systems, the method comprising:
obtaining, by a system control processor manager, a request to perform interception and auditing from a user; and
in response to obtaining the request:
identifying, by the system control processor manager, an interception and auditing intent associated with the request;
making a determination, by the system control processor manager, that the user is authorized to perform the interception and auditing intent; and
in response to the determination:
identifying, by the system control processor manager, a composed system associated with the request;
setting up, by the system control processor manager, interception and auditing services using an interception and auditing policy and function repository based on the intent; and
initiating, by the system control processor manager, performance of the interception and auditing services using an at least one control resource set of the composed system.

10. The non-transitory computer readable medium of claim 9, wherein the at least one control resource set comprises a system control processor.

11. The non-transitory computer readable medium of claim 10, wherein performing the interception and auditing services by the system control processor is transparent to a target user of the composed information handling system.

12. The non-transitory computer readable medium of claim 11, wherein the method further comprising:
after initiating the performance of the interception and auditing services using the at least one control resource set of the composed system:
obtaining, by the system control processor, a request to perform the interception and auditing services;
performing, by the system control processor, the interception and auditing services to obtain interception and auditing information; and
providing, by the system control processor, the interception and auditing information to the system control processor manager.

13. The non-transitory computer readable medium of claim 12, wherein the method further comprising:
after providing, by the system control processor, the interception and auditing information to the system control processor manager:
providing, by the system control processor manager, the interception and auditing information to the user.

14. The non-transitory computer readable medium of claim 9, wherein the interception and auditing policy and function repository comprises:
an interception and auditing policy; and
interception and auditing function mappings.

15. The non-transitory computer readable medium of claim 14, wherein setting up interception and auditing services comprises:
identifying the interception and auditing policy associated with the interception and auditing intent using the interception and auditing policy and function repository;
identifying functions associated with the interception and auditing policy using the interception and auditing function mappings; and
wherein performance of the interception and auditing services comprises executing at least one of the functions within an interception and auditing zone on the at least one control resource set, wherein the interception and auditing zone is associated with the interception and auditing intent.

16. The non-transitory computer readable medium of claim 9, wherein making the determination that the user is authorized to perform the interception and auditing intent comprises:
identifying a user identifier associated with the user included in interception and auditing access information; and
determining that the user identifier is associated with the intent.

17. A system for performing interception and auditing services for composed information handling systems, comprising:
a plurality of information handling systems, wherein the plurality of information handling systems comprise a plurality of system control processors; and
a system control processor manager, comprising a processor and memory, programmed to:
obtain, by a system control processor manager, a request to perform interception and auditing from a user; and
in response to obtaining the request:
identify, by the system control processor manager, an interception and auditing intent associated with the request;
make a determination, by the system control processor manager, that the user is authorized to perform the interception and auditing intent; and
in response to the determination:
identify, by the system control processor manager, a composed system associated with the request;
set up, by the system control processor manager, interception and auditing services using an interception and auditing policy and function repository based on the intent; and
initiate, by the system control processor manager, performance of the interception and auditing services using an at least one control resource set of the composed system.

18. The system of claim 17, wherein the at least one control resource set comprises a system control processor of the plurality of system control processors.

19. The system of claim 18, wherein performing the interception and auditing services by the system control processor is transparent to a target user of the composed information handling system.

20. The system of claim 19, wherein the system control processor is programmed to:
after initiating the performance of the interception and auditing services using the at least one control resource set of the composed system:
obtain a request to perform the interception and auditing services;
perform the interception and auditing services to obtain interception and auditing information; and
provide the interception and auditing information to the system control processor manager.
